(19) United States
(12) Patent Application Publication
(10) Pub. No.: US 2024/0065156 A1
(43) Pub. Date: Feb. 29, 2024

(54) COMBINE YIELD MONITOR AUTOMATIC CALIBRATION SYSTEM AND ASSOCIATED DEVICES AND METHODS

(71) Applicant: Ag Leader Technology, Ames, IA (US)

(72) Inventors: Tony Woodcock, Ames, IA (US); Roger Zielke, Huxley, IA (US); Nathan Risius, Huxley, IA (US); Allen Myers, Ames, IA (US)

(21) Appl. No.: 18/238,344

(22) Filed: Aug. 25, 2023

Related U.S. Application Data
(60) Provisional application No. 63/400,943, filed on Aug. 25, 2022.

(51) Int. Cl. A01D 41/127

(52) U.S. Cl. CPC A01D 41/1275; A01D 41/1272; A01D 41/1277

(57) ABSTRACT

The disclosed apparatus, systems and methods relate to automatic calibration systems, methods and devices for use with vehicle systems such as grain cart and combine vehicle systems to calibrate the yield monitor via collected calibration load profile data that is processed and used to calibrate and recalibrate the system automatically.

### CROSS-REFERENCE TO RELATED APPLICATION(S)

This application claims priority to U.S. Provisional Application No. 63/400,943 filed Aug. 25, 2022 and entitled “Combine Yield Monitor Automatic Calibration System Using Grain Cart with Weighing System,” which is hereby incorporated by reference in its entirety under 35 U.S.C. § 119(e).

### TECHNICAL FIELD

The disclosure relates to and automatic calibration system for use with agricultural vehicles, implements an equipment working in tandem, such as a combine harvester and grain cart.

### BACKGROUND

Many combines and other harvesting machines utilize sensors for measuring the mass flow of the grains or other biomass materials they harvest. The purpose of these mass flow sensors is to produce crop yield information based on discrete locations and/or regions within an agricultural field as well as crop yield information for the entire field. This is done by combining mass flow data with global positioning system data. Such information is utilized in subsequent agricultural operations in the field to improve yield or cost efficiency. Actions like varying the amount of fertilizer or seed applied to certain areas can either reduce the cost of inputs or increase potential yield. To produce high quality crop yield data, mass flow sensors need to be accurate, which means they need to be properly calibrated.

One known method for measuring mass flow in grain harvesting combines is based on measuring the force (with a load cell) of grain impacting an isolated surface. The mass flow sensor is typically placed at or near the top of the clean grain elevator, which is where the grain transitions from the harvesting part of the machine to the storage part of the machine. The components of the clean grain elevator (mainly the chain and paddles) tend to be unique to each combine. Additionally, the elevator chain and paddles tend to wear over time, which also can change the force-to-flow relationship of the mass flow sensor. This means that each combine has a unique calibration that can change over time. Another thing that can affect the mass flow calibration are the conditions of the grain. Kernel size, shape, density, and moisture can affect how force is imparted to the mass-flow sensor impact plate, which means that the calibration of the mass-flow sensor may need to change to accurately measure the flow of grain. Consequently, to achieve good accuracy from a mass flow sensor, it needs to be regularly calibrated.

The calibration process for mass flow sensors typically requires stopping the combine, initiating the calibration process on a yield monitor system, harvesting the required amount of grain needed for calibration, weighing that defined calibration load with an external weighing system, and entering the measured weight into the yield monitor system. While the calibration process is conceptually quite simple, the actual process requires extra time beyond the normal harvesting operation. Because harvest is a time-critical and expensive operation, many operators do not take the time to perform yield calibration while many others that do take time they wish were not required to, reducing efficiency.

Grain carts equipped with built-in weighing systems have become popular as a means for both calibrating combine mass flow sensors and tracking the amount of grain harvested and loaded to trucks. These built-in sensors allow for weighing to be completed as soon as the grain is unloaded from the combine. In some cases, large external displays on the grain cart allow combine operators to see the grain cart weight during unloading, allowing them to calculate the mass of the grain unloaded. Without a grain cart weighing system, the calibration process requires transporting a “calibration load” of harvested grain to a remote scale and then communicating the measured weight back to the combine operator for entry into the yield monitor system for comparison between the ground truth weight and the measured weight. As would be appreciated, this extra step adds inconvenience to the calibration process and the possibility of human error in determining the correct measured weight is entered for the calibration load. While grain carts with weighing systems make it easier for the combine operator to calibrate the system, it still requires conscious effort and action to complete the calibration process. What is needed is a system that can automatically initiate and follow the calibration process including measuring calibration load weights and transferring the data to the combine yield monitor system.

There is a need in the art for improved autocalibration approaches for these calibration systems.

### BRIEF SUMMARY

Described herein are various implementations relating to devices, systems and methods for automatic calibration. Although multiple implementations, including various devices, systems, and methods of autocalibration are described herein as an “calibration system,” this is in no way intended to be restrictive.

The devices, systems, and methods herein provide an automatic calibration system for a mass flow sensor that uses a grain cart and its on-board weighing system to measure a calibration load or loads so as to optimize the calibration for the yield monitor and associated sensors. The system and methods presented utilize feedback and further processing techniques to account for the fact that grain cart weighing system is typically an imperfect weighing instrument, and the disclosure utilizes one or more of the disclosed methods to reduce the inaccuracy of the weighing system, which will improve the accuracy of the yield monitor, mass flow sensor calibration and other features.

In Example 1, an automatic calibration system comprising a combine vehicle system, comprising a first operations unit; at least one combine sensor; and a yield monitor configured to collect yield monitor data from the at least one combine sensor; a grain cart vehicle system, comprising a second operations unit configured to collect grain cart system data; and a data link between the combine vehicle system and grain cart vehicle system, wherein the calibration system is configured to: record a calibration load profile from the collected yield monitor data; verify the recorded calibration load profile with grain cart system data; update the calibration load profile; and calibrate the yield monitor with the updated calibration load profile.

In Example 2, the automatic calibration system of any of Example 1, wherein the at least one combine sensor comprises a mass flow sensor and the calibration system is configured to calibrate the mass flow sensor.

In Example 3, the automatic calibration system of any of Examples 1-2, wherein the calibration system is configured to determine that the combine grain tank is empty via unload timing, via unload rotations, via material out sensor or via grain cart weight system.

In Example 4, the automatic calibration system of and of Examples 1-3, further comprising at least one GNSS system.

In Example 5, the automatic calibration system of any of Examples 1-4, wherein the first operations unit is housed in a display.

In Example 6, the automatic calibration system of any of Examples 1-5, further comprising a cloud system.

In Example 7, the automatic calibration system of any of Examples 1-6, wherein the yield monitor data comprises at least one of raw mass sensor force data or flow data, crop type data, calibration load time and date, calibration load duration, moisture data, number of unloads and crop variety data.

In Example 8, an automatic calibration system comprising a combine vehicle system, comprising a yield monitor configured to collect yield monitor data from at least one combine sensor; a grain cart vehicle system configured to collect grain cart system data; and a data link between the combine vehicle system and grain cart vehicle system, wherein the calibration system is configured to: record a calibration load profile from the collected yield monitor data; update the calibration load profile; and calibrate the yield monitor with the updated calibration load profile.

In Example 9, the automatic calibration system of Example 8, wherein the yield monitor data comprises at least one of raw mass sensor force data or flow data, crop type data, calibration load time and date, calibration load duration, moisture data, number of unloads and crop variety data.

In Example 10, the automatic calibration system of Example 8 or 9, wherein the grain cart system data comprises at least one of grain cart weighing system data, grain cart ID data, grain cart start weight data, grain cart location data, grain cart loading or unloading date and time, grain cart tilt, roll and pitch, grain cart speed data during loading or unloading, grain cart stop weight data, and grain cart load duration data.

In Example 11, the automatic calibration system of Example 8, 9 or 10, configured to process and verify calibration load profiles and apply corrections.

In Example 12, an automatic calibration system comprising a combine vehicle system, comprising a yield monitor configured to collect yield monitor data and record a calibration load profile from the collected yield monitor data; and a grain cart vehicle system comprising a grain cart weighing system configured to compile grain cart weight data, wherein the combine vehicle system and grain cart vehicle system are in operational communication and are configured to automatically calibrate at least one of the yield monitor and/or grain cart weighing system.

In Example 13, the automatic calibration system of Example 12, further comprising a data link between the combine vehicle system and grain cart vehicle system.

In Example 14, the automatic calibration system of Example 12 or 13, wherein the grain cart weighing system is configured to calibrated via linear correction.

In Example 15, the automatic calibration system of any of Examples 12-14, wherein the grain cart weighing system is configured to calibrated via non-linear correction.

In Example 16, the automatic calibration system of any of Examples 12-15, wherein the yield monitor and weighing systems are configured to be initially calibrated by comparing start and stop weights with ground truth weights.

In Example 17, the automatic calibration system of any of Example 12-16, wherein yield monitor and grain cart weighing system are configured to be automatically calibrated for crop conditions.

In Example 18, the automatic calibration system of any of Examples 12-17, wherein configured to score calibration load profiles via bin sigma and/or speed distribution score.

In Example 19, the automatic calibration system of any of Examples 12-18, configured to execute a linear increasing correlator to establish at least one of unload start time and/or unload stop time.

In Example 20, the automatic calibration system of any of Examples 12-19, configured to process grain cart load profiles and/or grain cart weight system weight by applying at least one correction selected from the group consisting of: an upper and lower range calibration; a linear calibration correction; a bi-linear calibration correction; a multi-point calibration correction; a motion correction; a crop type corrections; and a combine speed correction.

In the various Examples, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other implementations of these Examples include corresponding computer systems, apparatus, and computer programs recorded on one or more computer storage devices, each configured to perform the actions of the methods.

Implementations of the described techniques may include hardware, a method or process, or computer software on a computer-accessible medium.

Certain Examples of the disclosed system relate to the use of a grain cart ID. In a harvest operation, it is understood that there may be multiple grain carts servicing one or more combines. In Examples of the system operating in these environments, a unique ID can be associated with each grain cart such that the information that a grain cart collects is associated to that specific unique ID. This unique grain cart ID data may include logged data and/or calibration parameters such that data derived from an individual grain cart is associated with that grain cart in the system, for example by the serial number of a component in the grain cart, such as a display, the electronic weighing system or the like.

While multiple implementations are disclosed, still other implementations of the disclosure will become apparent to those skilled in the art from the following detailed description, which shows and describes illustrative implementations of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a system diagram view of an exemplary implementation of the calibration system having a combine vehicle system and grain cart vehicle system.

FIG. 1B is schematic diagram showing vehicle system component architectures, according to certain implementations.

FIG. 2A is a flow chart depicting an exemplary set of recording and processing steps, according to certain implementations.

FIG. 2B is a flow chart depicting an exemplary set of recording and processing steps, according to certain implementations.

FIG. 3A is a flow chart depicting an exemplary set of executed steps by the system, according to certain implementations.

FIG. 3B is a further flow chart depicting an exemplary set of executed steps by the system, according to certain implementations.

FIG. 4 is a flow chart depicting an exemplary set of executed steps by the system, according to certain implementations.

FIG. 5 is a further flow chart depicting an exemplary set of executed steps by the system, according to certain implementations.

FIG. 6 is a graph depicting an exemplary combine unload rate for corn.

FIGS. 7A-7C depict an observed grain cart weight and corresponding linear span and linear score algorithms over time.

FIG. 8 depicts a graph of estimated weight vs. actual weight throughout loading with an incorrect calibration

FIG. 9 is a graph depicting bilinear behavior in a grain cart weighing system.

FIG. 10 is a scatterplot showing calibration load error by start weight.

FIG. 11 is a combined scatterplot and best fit line graph depicting calibration load force-to-flow delineated by measuring range.

FIG. 12 is a scatterplot of recorded calibration loads adjusted for secondary grain cart collection.

FIG. 13 depicts a line graph representing measured and actual/ideal weight with an example multi-point calibration process for the grain cart weighing system, according to certain implementations.

FIG. 14 depicts a line graph of weight and velocity over time demonstrating grain cart weighing system motion-induced signal noise.

FIG. 15 depicts a combined scatterplot and best fit line graph depicting the loads and calibration, respectively, demonstrating a calibration of the system based on crop conditions, according to certain implementations.

FIG. 16 is a bar graph depicting load distribution and bin sigma for Load A and Load B, according to the implementation of FIG. 15.

FIG. 17 is a bar graph depicting load distribution for combine speed for Load A and Load B, according to the implementation of FIG. 15.

### DETAILED DESCRIPTION

The automatic calibration system 10 disclosed herein is configured to collect combine mass flow sensor and associated yield monitor sensor data as well as grain cart data for a number of calibration loads to calibrate the combine yield monitor automatically, without manual calibration by the operator. That is, in various implementations, the system is collecting calibration load profile data from the calibrated combine yield monitor and sensors and using collected grain cart data to validate and/or update the calibration of the yield monitor system in an iterative process to improve the performance and accuracy of the yield monitor system calibration.

It is understood that as discussed herein, a calibration load is a discrete amount of grain collected during harvest that is dispensed from a harvester to a receptacle, such as a grain cart, that has a weighing system that determines an actual weight for the finite amount of grain. These calibration loads may be dispensed in a single session or over multiple unload sessions, with each unload session being individually weighed and recorded by the unload receiving/weighing system. The weights for each unload session of the calibration load are added together to produce a single actual weight for the calibration load. The associated calibration load profile would be all the yield monitor system data collected during the harvesting and multiple unload sessions of the calibration load.

Each calibration load discussed herein has a calibration load profile, which is the sampled data from the mass flow sensor and other sensors of the yield monitor system discussed herein, taken during harvesting of the calibration load. This sensor data is primarily sensor value data that is measured and recorded over a given frequency, as would be understood.

As described herein, the calibration load profile and the measured weight of the calibration load taken by the weighing system allows the various calibration algorithms discussed herein to adjust yield monitor calibration to minimize the error between the estimated weight calculated by the yield monitor system and the actual weight as measured. The calibration algorithms described herein can use multiple calibration load profiles and associated actual measured weights to adjust the calibration and minimize the error over the multiple calibration loads, thus producing an “average” calibration that produces better results than a single load calibration. The calibration can be understood as a series of factors that are applied to the raw sensor data of the mass flow sensor and associated sensors of the yield monitor system to produce a “calibrated” mass flow that can be recorded and mapped by a field computer.

The various implementations of the calibration system 10 collect data from sensors disposed on the combine and grain cart to calibrate—and validate the calibration of—the yield monitor and associated sensors. These implementations automatically adjust the yield monitor calibration when it changes. The calibration system 10 according to certain implementations is also configured to collect data from a number of calibration loads to establish an average calibration for a given crop, as well as collect yield monitor calibration loads across varied crop conditions for storage and use, such that the calibrations can be applied by the system on the basis of those crop conditions, such as moisture range, variety, test weight range and the like.

Therefore, various implementations of the calibration system 10 presented herein generally relate to the intake, syncing and processing of calibration load data that is shared between two machines or vehicle systems (such as a combine and grain cart) and used to record calibration load profile data for storage and use by certain components of those vehicle systems, including sensors and the yield monitor. That is, for example, data collected from two vehicle systems, such as a combine system 12 and a grain cart system 14 are processed to calibrate or recalibrate the flow meter, yield monitor or other components, as will be understood here.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/215,721, filed Jun. 28, 2023, entitled “Seed Tube Guard and Associated Systems, Devices, and Methods of Use,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” and U.S. Patent Application 63/525,525, filed Jul. 7, 2012, entitled “Assisted Steering Systems and Associated Devices and Methods for Agricultural Vehicles,” each of which is incorporated herein by reference.

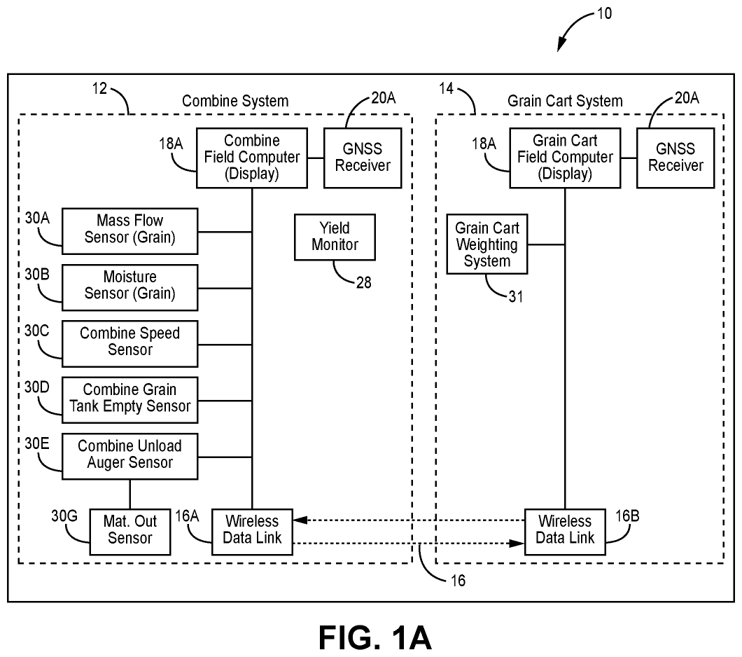

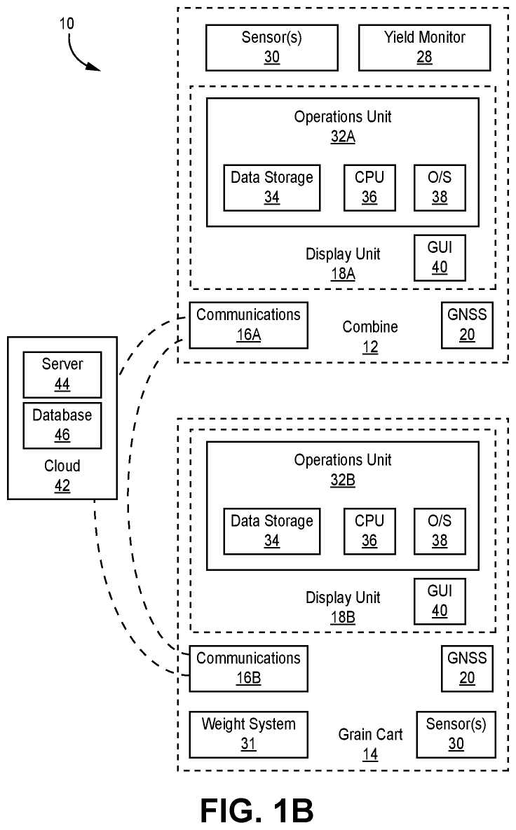

Returning to the disclosed calibration system 10, in the implementation of FIG. 1A, the system 10 comprises a plurality of vehicle systems, namely a combine vehicle system 12 and a grain cart vehicle system 14 in operational communication with one another, and grain harvested by the combine 12 is unloaded into the grain cart 14, where it can be weighed by the grain cart weighing system 31. It is appreciated that in alternate implementations, other vehicle system types may be utilized in place of these vehicle systems, such as others that employ a yield monitor.

In the implementation of FIG. 1A, the combine system 12 and grain cart system 14 also comprise one or more optional components, such as a field computer 18A, 18B which can be a display 18A, 18B such as InCommand® display from Ag Leader®.

In various implementations, the vehicle systems 12, 14 are further configured to share information through a wireless data link 16 or other wired or wireless communications system understood in the art. It is further understood that the data link 16 may consist of data link components 16A, 16B on each of the vehicle systems 12, 14. For example, in certain implementations the wireless data link 16 may be implemented with any of a number of wireless technologies and their combinations including, but not limited to, point-to-point digital radios, a low-rate personal area network (LR-WPAN) as described by the IEEE 802.15.4 standard, wireless area network (WAN) as described by the IEEE 802.11 series of standards, or cellular modem connected to a cloud-computing system.

Continuing with the implementation of FIG. 1A, the combine system 12 and grain cart system 14 can also include a GNSS or GPS receiver 20, one or more sensors 30 in operational communication with the relevant vehicle system displays 18A, 18B and operations units 32A, 32B, as is shown in greater detail in FIG. 1B.

Continuing with FIG. 1A and as shown in FIG. 1B, in various implementations, each of the vehicle system displays 18A, 18B comprise an operations unit 32A, 32B in operational communication with data link 16 components 16A, 16B. It is generally understood that these components can occasionally be housed within the display unit 18A, 18B and that the representation of FIG. 1B is merely exemplary.

In certain implementations, the operations units 32A, 32B are also configured for the sending and receiving of data for storage and processing, such as to the cloud 42, a remote server 44, database 46, and/or other cloud computing components readily understood in the art. Such connections by the operations units 32A, 32B can be made wirelessly via understood internet and/or cellular technologies such as Bluetooth, WiFi, LTE, 3G, 4G, or 5G connections and the like. It is understood that in certain implementations, the operations units 32A, 32B and/or cloud 42 component comprise encryption or other data privacy components such as hardware, software, and/or firmware security aspects.

Continuing with FIG. 1B, each of the operations units 32A, 32B, according to certain implementations, further has one or more optional processing and computing components, such as data storage 34, a CPU or processor 36, operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

As shown in FIG. 1B and returning to FIG. 1A, the system comprises at least one yield monitor 28 and each of the vehicle systems 12, 14 comprises one or more sensors (shown generally at 30) that are in operational communication with the vehicle systems 12, 14 and operations units 32A, 32B via the communications systems or data link 16A, 16B. It is understood that in certain implementations, the yield monitor 28 is in direct operational communication with some or all of the various sensors 30A-G, and that it is calibrated to utilize raw data values generated by those sensors to perform the various estimations and data value recordings described herein. In various implementations, therefore, the yield monitor 28 may be operating on, for example, the combine system 12 but be in operational communication with both vehicle systems 12, 14, such as via the data link 16, as would be readily appreciated.

In certain implementations of the combine system 12, for example, the sensors can include a grain mass flow sensor 30A, a grain moisture sensor 30B, a combine speed sensor 30C, combine grain tank empty sensor 30D, a combine unload auger sensor 30E, and material out sensor 30G and others that are interconnected with the display 18 and yield monitor 28 For analysis and use by the combine system 12, yield monitor 28 and display 18A, as would be understood.

In a grain cart system 14, the sensors 30 can comprise a grain cart weighing system 31 and others, as will be readily apparent to those of skill in the art. It is further appreciated that each of the sensors 30A-F and systems 10, 12, 14, 31 described herein may produce a time-series of data that is used in the subsequent processing steps, such as to establish start/stop times, weights over time and the like, and that each of these raw series of values can be compared with established thresholds that are inputted manually, defined by the system and/or updated over time, such as via machine learning techniques understood by those of skill in the art. It is further understood that the various steps and sub-steps depicted in the accompanying diagrams and flow charts are provided as exemplary, and that the routes of data or value transmission from the various components can be accomplished by a variety of approaches, each of which is contemplated herein.

In various implementations, the system 10 is configured to calibrate the combine yield monitor 28 without requiring the combine operator to perform a manual calibration process. That is, in various implementations the system 10 is configured to collect data from the various sensors for recordation and processing as a calibration load profile that can be used to either calibrate the yield monitor 28 or validate the current calibration of the yield monitor 28 or other components, such as the various sensors 30A-E, such as the grain mass flow sensor 30A and others.

Certain examples presented here utilize certain of the mass-flow sensor calibration techniques presented in U.S. Pat. No. 5,369,603, which is incorporated by reference in its entirety. In these processes, the non-linear sensor calibration curve is determined using a series of linear segments (the described implementation used 10). Another aspect of the devices, systems, and methods described herein is that all mass-flow information is collected and stored in raw form, which is a measurement of force over a sampling period (e.g. 1 second). The measurement of mass flow is dependent on the actual calibration (a series of linear segments correlating a force range to flow) that is applied to the raw sensor force. Such techniques can be adapted for use in the various calibration processes described herein.

In certain implementations, the calibration system 10 is configured to record yield monitor calibration load profiles from the combine system sensor data/yield monitor data to establish target average calibrations for the defined crop. For example, the system 10 according to certain implementations collects these yield monitor calibration load profiles across different crop conditions so calibrations can be applied based on specific crop conditions, such as moisture range, variety, test weight range and others and automatically adjust the yield monitor 28 calibration for a given crop or conditions to more accurately reflect ground truth as determined by the measure grain cart calibration load weights synced to the system 10.

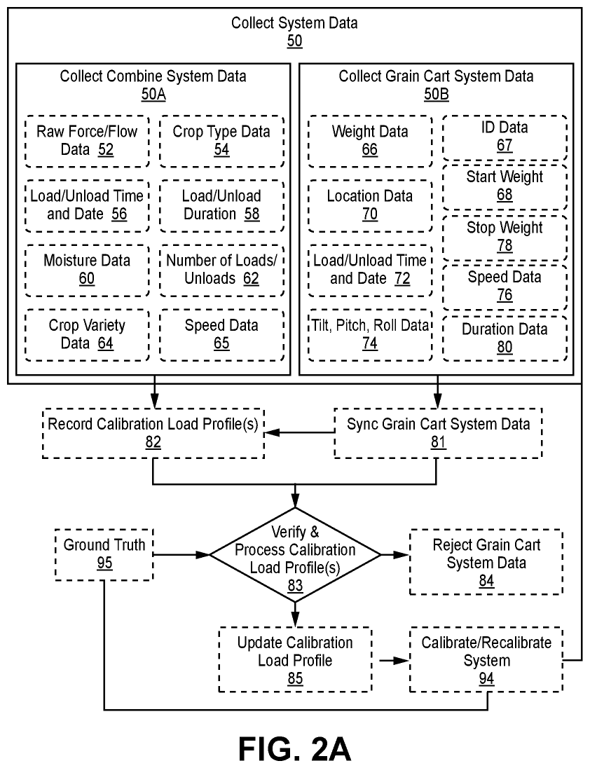

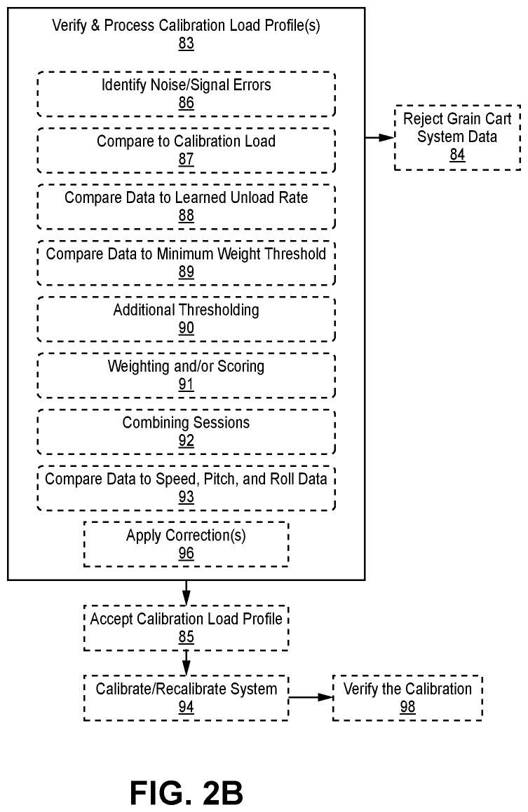

As shown in FIG. 2A, in various implementations the calibration system 10 is configured to collect vehicle system data (shown generally at boxes 50A and 50B) from a first vehicle system 12, such as the combine vehicle system 12 and a second vehicle system 14, such as the grain cart vehicle system 14 for use in generating and updating calibration load profiles and subsequently the calibration of the system.

In various implementations, the combine vehicle system data 50A or yield monitor data 50A can include mass flow sensor data, empty and unload status information relating to the calibration load and other data, as described herein. In various implementations the grain cart vehicle system data (box 50B) or grain cart calibration load data can include data related to the actual weight of a calibration load recorded by the grain cart 14 including by the grain cart weighing system 31 data. The collected data (box 50A) such as yield monitor data can then be processed to record calibration load profile data (box 82) which is synced with grain cart calibration load data (box 50B) and used to calibrate the relevant systems (box 94), such as the various sensors 30, the yield monitor 28 and the grain cart weighing system 31. It is appreciated that the calibration load profiles may be recorded over several sessions as described below, and processed contemporaneously or successively to record the calibration load profile for calibration, as described above.

Continuing with the implementation of FIG. 2A in greater detail, the system 10 is configured to collect vehicle system data (box 50) from the vehicle systems, that is from the combine system 12 and grain cart system 14. Collected combine vehicle system data (box 50A) can optionally comprise sensor data, component data and/or stored data, certain optional examples including raw mass sensor force data or flow data (box 52), crop type data (box 54), calibration load time and date (box 56), calibration load duration (box 58), moisture data (box 60), number of unloads (box 62), crop variety data (box 64) and other forms of sensor, component and/or stored data, as would be readily appreciated by those of skill in the art. This collected combine vehicle system data (box 50A) can be used in the recording a calibration load profile (box 82).

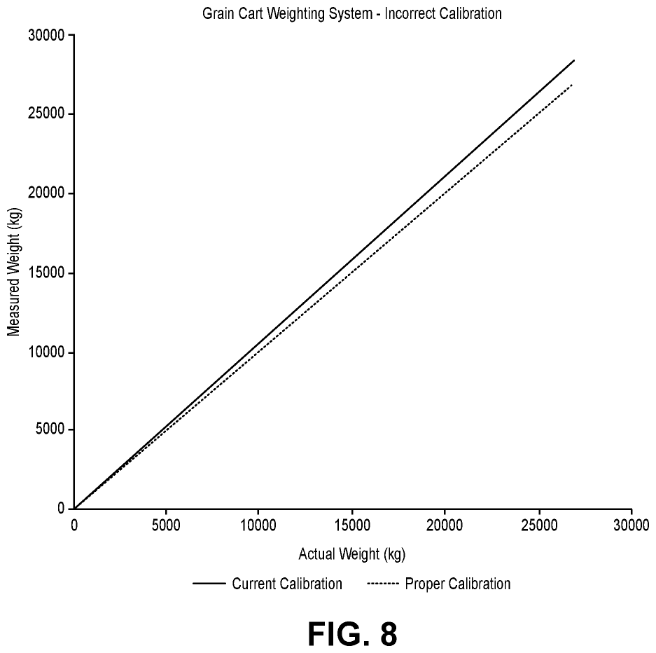

Continuing further with the implementation of FIG. 2A, the system 10 is also configured to collect grain cart calibration load data 50B from the grain cart system 14 during loading (loads) and/or unloading (unloads). This collected grain cart vehicle system data (box 50B) can optionally comprise sensor data, component data and/or stored data when an unload session is initiated, certain optional examples including weight data (box 66) which can comprise data related to the weight of the calibration load at a point in time and/or the weight of the laden grain cart/and or truck, as would be appreciated, as well as the above-described grain cart ID data (box 67), grain cart start weight data (box 68) and grain cart stop weight data (box 78), as well as other data such as grain cart location data (box 70), grain cart loading or unloading date and time (box 72), grain cart tilt, roll and pitch data (box 74), grain cart speed data during loading or unloading (box 76), grain cart load duration data (box 80) and other forms of grain cart sensor, component and/or stored data, as would be readily appreciated by those of skill in the art. This collected grain cart vehicle system data (box 50B) can be synced (box 81) and used in the verifying and processing (box 83) a calibration load profile (box 82) to update the calibration load profile (box 85) for calibration or recalibration of the system (box 94). It is appreciated that in certain implementations, certain ground truth data (box 95) can also be inputted into the system for use in the verifying, processing and correction of calibration load profile data, as would be understood. For example, terminal scale weight data can be inputted as a ground truth, as explained in detail at FIG. 8.

That is, according to these implementations, the collected data 50A, 50B is optionally synced (box 81) between the vehicle systems 12, 14, such as via the data link 16, and used to record a calibration load profile (box 82), where it is processed and/or verified (box 83) by the system 10 via one or more of the operations units 32A, 32A shown in FIGS. 1A-1B and either rejected (box 84) or accepted and used to calibrate (box 85) the various sensors 30 and/or yield monitor 28 to reflect accurate ground truth calibration load information and improve the performance of the yield monitor and systems through more accurate calibration of those components to the present conditions.

Continuing with FIG. 2B, the calibration load profile verifying and processing (box 83) can include, in any order, assessing noise or signal errors in the calibration load profile (box 86) comparing actual ground truth calibration load weight (box 87) to the calibration load profile. In certain implementations, the processing (box 83) can also optionally include processing the calibration load profile by comparing it to learned unload rate data (box 88), comparing the calibration load profile to a minimum weight threshold (box 89), comparing data to other defined thresholds (box 90), combining calibration load profile sessions (box 91), weighting and/or scoring the calibration load profile (box 92), using speed, pitch and/or roll data (box 93), and other processing steps as would be apparent to those of skill in the art from the disclosure. It is appreciated that each of these optional processing sub-steps can be included or omitted, and can be used to revise and/or reject the calibration load profile as needed during the verifying and processing step (box 83).

In a further optional step depicted in FIG. 2A-2B, the system 10 is configured to calibrate or recalibrate the systems (box 94) on the basis of the recorded, processed and accepted (box 85) calibration load profile. In various implementations, this calibration or recalibration can comprise the use of the current calibration load profile to calibrate the system (box 96) including the yield monitor 28, mass flow sensor 30A and/or other sensors 30B-E and optionally also use the calculated calibration load profile to verify the calibration (box 98). That is, the system 10 can use the newly-recorded, processed and accepted calibration load profile to both calibrate and verify the current calibration of the system and sensors.

That is, in various implementations, the calibration load profile is used to vary the current (or active) calibration. If the calibration load profile estimated weight (using the current calibration applied) and its associated calibration load measured weight are within some pre-set or configurable error threshold (for example 1%), the calibration is not updated with the new calibration load profile. The calibration load profile will be saved and may be used in a calibration update later. If the calibration load profile estimated weight differed from the measured weight in excess of the error threshold, a new calibration would be generated immediately using the new, updated, information.

In use according to these implementations, the various calibration load profiles are started (and stopped) on combine empty transitions, which can be determined by the combine vehicle system 12 and/or grain cart vehicle system 14. For example, during a harvesting operation, when the combine 12 is determined to be empty, a new calibration load profile is automatically created by the system 10. If there is an active calibration load profile when the combine is determined to be empty, the active calibration load profile is stopped and then a new calibration load profile is created and becomes the active calibration load profile.

If unloading occurs without the combine 12 being detected as empty, the unload start and stop weights (and other unload information) are recorded as normal and the unload weight is added to the active calibration load profile. A calibration load profile may have one or more unloads associated with it and defining its actual weight. Depending on the operation mode for the calibration system 10, multi-unload calibration load profiles may or may not be used to calibrate the yield monitor 28. It is understood that the use of multiple sessions allows for pausing and resuming unloading the combine into the grain cart on-the-go in field conditions. For example, this allows the system 10 to pause unloading on-the-go while turning around on end rows unloading on-the-go when the combine and grain cart are in position after the turn. Other such field conditions and situations would be readily appreciated.

Various implementations of the system 10 allow for the determining of accurate starting (box 68) and ending weights (box 78) for the grain cart 14. In one implementation of the calibration system 10, grain cart weight averaging is employed via sampling and buffering. In such implementations, the grain cart weight is sampled at a constant rate (for example about 1-2 Hz) and then stored in a memory buffer to allow a stable unload start weight to be determined by averaging data over a period of time before unloading started. In one implementation, a buffer of 30 seconds (30 samples) of 1 Hz sampled weight data was stored. For example, the unload start weight (box 68) can be calculated as the average of 10 seconds (samples) taken 5 seconds prior to unload starting.

When unloading is completed, determining the stop or ending weight (box 78) for the unload is delayed while the grain cart weight stabilizes after the unload. In one such implementation, the calibration system 10 waits for a defined period such as 5 seconds after unloading stops and then collects an additional 10 seconds of grain cart weights, which are averaged to produce the stop weight for the unload. The unload weight is calculated as the stop weight minus the start weight. If the combine 12 was emptied and a calibration load profile was stopped, this unload weight is then assigned as the measured value for the just-completed calibration load profile. If the combine was not emptied and there is an active calibration load, the unload weight is added to the measured value for the current calibration load profile.

There can be a certain amount of signal noise in the grain cart 14 weighing system 31, especially when the grain cart 14 is in motion. To deal with this signal noise, when the calibration system 10 reads the grain cart weight it averages the readings over a number of samples. In one implementation it was determined that averaging the weight readings over about 10 seconds produced a reasonably accurate and stable weight, though other durations are of course possible.

Various implementations of the calibration system 10 utilize a variety of approaches for collecting data from calibration loads and recording calibration load profile data, as described herein.

I. Empty Detection and Verification.

In order to start the calibration process according to certain implementations, the combine 12 grain tank must be verified as empty. The system 10 is therefore configured to determine that the combine grain tank is empty, according to certain implementations. It is appreciated that this includes both the grain tank and unload auger being empty. In various implementations, the combine grain tank is verified as empty via one or more of the following approaches, such as on the basis of a defined duration, number of rotations or other measurable characteristic.

A. Unload Timing After Empty Sensor. In certain implementations, the system 10 is configured to record unload timing after the empty sensor is detected. In these implementations, the combine unload auger sensor 30E is configured to indicate that the unload auger is running for a defined amount of time—an unload-empty threshold—after the combine grain tank empty sensor indicates that it is empty. The unload-empty threshold is a setting that is determined based on the placement of the combine grain tank empty sensor 30D and the throughput of the unload auger, as would be understood. After the combine grain tank empty sensor 30D indicates that it is empty, it is understood that in real world conditions, the combine grain tank and unload auger will still contain a certain amount of grain. As the unload auger continues to run after the empty indication, it will evacuate this remaining grain in a certain amount of time that equals the empty run time threshold. If the unload auger does not run for the threshold time, the combine grain tank is considered not empty in these implementations. The unload-empty threshold is a user setting that is accessible through the user interface 40 on the combine field computer or display 18A.

B. Unload Rotations After Empty Sensor. In certain implementations, the system 10 is configured to record unload rotations after the empty sensor is detected. In various implementations, the combine unload auger sensor 30E may be a rotational sensor that allows for the determination of the number of rotations of the unload auger. Instead of establishing whether or not it is empty based on the empty sensor and the unload time, as discussed above, the unload rotations are used. In these implementations, the unload-empty threshold is defined as a value for number of rotations after empty indication. If the number of rotations after empty is not met, the grain tank is considered not empty.

C. Material Out Sensor After Empty Sensor. In certain implementations, the system 10 is configured to monitor a material out sensor 30G to verify that the grain tank is empty. In various implementations, the combine unload auger may have a material-out sensor 30G placed at the end of the unload auger configured to measure the presence or absence of grain being expelled from the unload auger. That is, according to these implementations, when the unload auger is running, the material-out sensor will detect grain until the grain tank and unload auger are emptied. This method does not require a time or rotations unload-empty threshold for determining the grain tank to be fully emptied, but instead can define the unload-empty threshold as a binary presence or absence of grain as established by the material-out sensor 30G.

Various implementations can make use of a variety of material out sensors 30G including, but not limited to: a physical switch with an apparatus that forces the switch to be deflected when grain is exiting the unload auger; a capacitive proximity sensor detects the presence of nearby grain; an optical sensor consisting of transmitter receiver pair where grain exiting the unload auger blocks the transmission of light between transmitter and receiver; an optical sensor that detects the presence of grain as reflected light from the transmitter to the receiver; a flexible element with embedded magnet and magnetic sensor that measures deflection of the element to determine if unloading grain is impacting the element or others as would be readily appreciated in the art.

D. Grain Cart Weight Stops Increasing After Empty Sensor. In various implementations, the weight measured by the grain cart weighing system 31 may also be used to determine that the combine grain tank is empty. In these implementations, the measured weight of the grain cart 14 is transferred through the data link 16 to the combine 12. The combine 12 monitors the grain tank empty sensor 30D and unload auger status sensor (off/on). When the grain tank empty sensor 30D indicates empty and the unload auger is running, the grain cart weight is monitored. When the grain cart weight stabilizes (stops increasing) and remains stable for short period of time (for example about 2-5 sec), the combine grain tank is considered empty.

II. Calibration Load Profile Recordation.

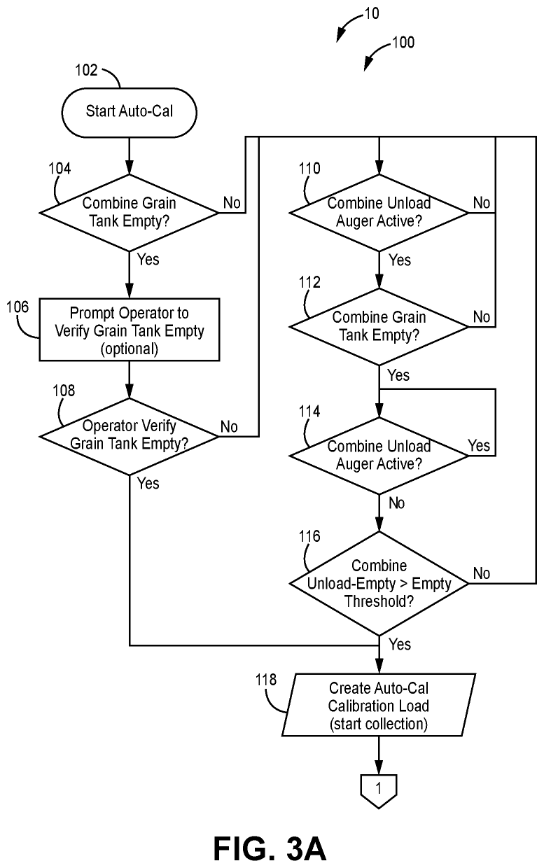

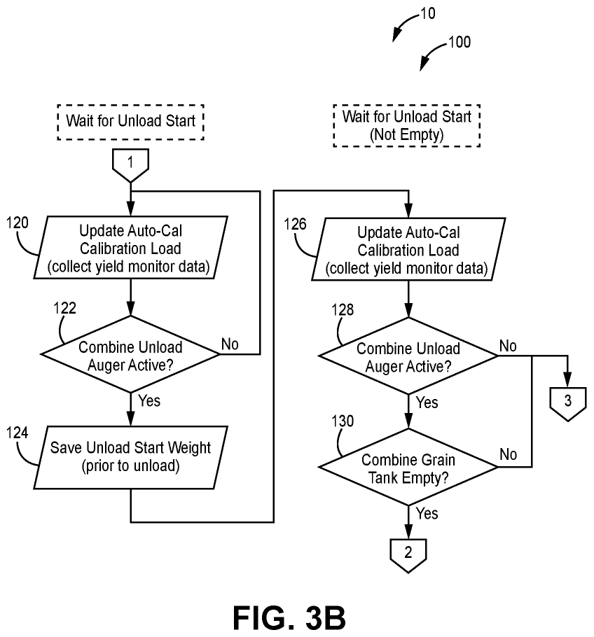

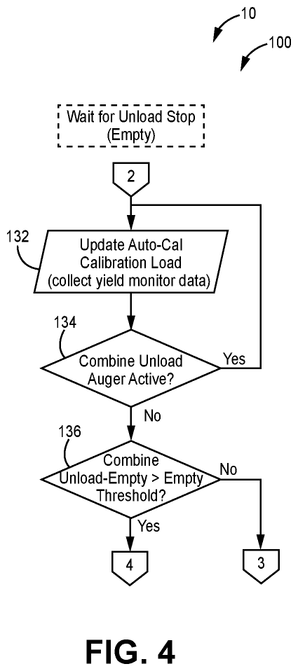

FIGS. 3A-5 are an exemplary flow chart of the recording of a calibration load profile recordation and verification process 100 according to certain implementations of the system 10. In various implementations, the calibration load is used to calibrate, for example, the yield monitor 28, mass flow sensor 30A and other sensors 30 and processing components, as described above.

These implementations are intended to be exemplary and in no way limiting to a specific series of steps. As with the other figures, each of the steps and sub-steps described in relation to FIGS. 3A-5 can be performed in any order, omitted or substituted for alternate steps as would be readily appreciated. It would be understand that various of the steps and/or sub-step may be performed sequentially, concurrently, and/or iteratively.

One implementation of the system 10 in use is shown in the calibration load recordation and verification process 100 depicted in FIG. 3A. In these implementations, when the combine 12 and grain cart vehicle systems 14 are started, there is no calibration load profile active. The system 10 will remain in an inactive state until the empty status is verified, as above.

According to these implementations, when the combine is started (box 102), if the grain tank empty sensor is indicating that the grain tank is empty (box 104), the operator is prompted to verify that the grain tank is empty (box 106). If the operator verifies the empty state (box 108), then a calibration load profile is automatically started. If not (“no”), the system will wait until the empty status is verified by monitoring the unload auger status (box 110) and empty sensor status (box 112). When the unload auger status (box 110) indicates unloading, the empty sensor status (box 112) is monitored. If the empty status (box 112) indicates empty and the unload auger status (box 114) remains active for the empty time threshold (box 116) a new calibration load profile is automatically started when the unload auger is stopped. Other methodologies of verifying the empty status, discussed elsewhere, may be used.

As shown in FIG. 3B, once a calibration load profile is active, the system records yield monitor 28 data to the calibration load profile and monitors for combine unloads (box 120). Each combine unload will be recorded, regardless of whether the combine grain tank is completely emptied during the unload. When the unload auger status indicates unloading (box 122), the weight of the grain cart is recorded as the start weight of the unload (box 124). The actual start weight (box 68 in FIG. 2A) recorded will be based on the average of grain cart weight data that was received just prior to the unload starting. In one implementation, a time of 5 seconds was used as the pre-unload sample time. In one exemplary implementation, weight samples from about 5-15 seconds before unload were averaged to produce the starting weight.

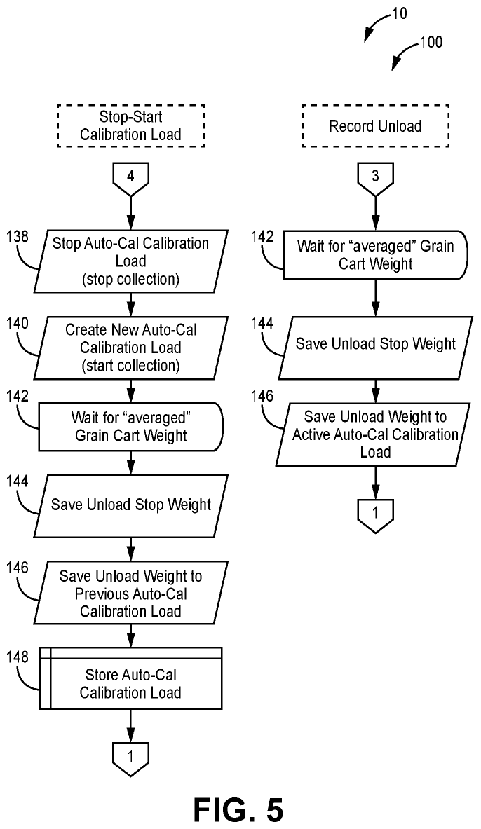

Once unloading starts, the system 10 monitors the unload status (box 128) and empty sensor status (box 130) until unloading stops. If unloading stops prior to the empty sensor indicating empty (box 128), the system goes to the “record unload” state (as is shown in FIG. 5). Here it will wait a set amount of time after unloading has stopped and there has been enough grain cart weight samples after unload to create a good average weight (box 142). This will be the unload stop weight (shown in FIG. 2A at box 78). In one implementation, the system waits 5 seconds after unloading stops, then samples grain cart weights for 10 seconds and averages the weights to produce the unload stop weight. Once the unload stop weight is recorded (box 144), the unload weight is calculated as the unload stop weight minus the unload start weight. When there is no transition to a new calibration load profile, the unload information is added to the active calibration load profile (box 146). If a new calibration load profile is created, the unload information is added to the previous calibration load profile. It is understood that several calibration load profiles can be combined.

If unloading stops after the empty sensor has indicated empty (box 130), the system 10 checks how long the unload auger was active after empty status indicated empty (box 132). If the time exceeds the empty threshold, then the combine is deemed empty (box 136). The current calibration load profile recordation is stopped (box 138), a new calibration load profile is started (box 140), and the system enters the “record unload” state as described above (box 142), (box 144), (box 146), (box 148). If the time does not exceed the empty threshold (box 136), the combine is determined to be not-empty and no new calibration load profile is created. The system enters the “record unload” state as described above (box 142) (box 144) (box 146). While the unload stop weight is being determined, the system continues to update the active calibration load profile.

The active calibration load profile will remain active until either a combine grain tank empty event occurs (box 130) or the calibration system 10 shuts down. Shut down occurs when any or all the combine vehicle system components are powered down or a system reset occurs. Since calibration load profile collection will remain active until a combine grain tank empty occurs (box 130) a single calibration load profile can have multiple unloads, which determine the measured weight.

According to certain implementations, once a calibration load profile is collected, it must exceed the minimum weight needed for calibration to be used, as would be appreciated. Calibration load profiles that do not meet the minimum weight are rejected and not used in the calibration process. In one implementation, the minimum load weight for a calibration load is 3000 lbs (1360 kg). However, this minimum load weight threshold may change depending due to factors with the combine and/or grain cart weighing system. It is understood that the minimum calibration load weight according to certain implementations should be sufficiently large to minimize the variability in sampling low weights.

Alternative Methods for Determining Grain Cart Start and Stop Weights. In another implementation of the calibration system 10 the starting weight (box 68) may be determined according to an algorithm like the following. In these implementations, the grain cart speed (box 76) is constantly monitored by the calibration system 10. Tractors that tow grain carts typically have a wheel speed sensor 30C or radar to determine the ground speed, as shown in FIG. 1A. This ground speed is typically output on the vehicle CAN bus, which can be monitored by the calibration system 10, as would be appreciated.

As is also shown in FIGS. 1A-1B, the grain cart vehicle system 14 may also be equipped or otherwise in communication with a GNSS/GPS receiver 20 mounted on the tractor that can also produce a grain cart ground speed (shown, for example, at box 76). It is understood that the grain cart weighing system 31 often produces the most stable reading when the grain cart is stationary, and accordingly, the calibration system 10 is configured to store the last stationary weight measured by the grain cart.

When an unload occurs, it will use the last recorded stationary weight as the start weight (box 68) for the unload. After a combine unload occurs, the calibration system 10 will wait until the grain cart stops moving for a sufficient time to stabilize the load and record a stable weight that is then used for the stop weight (box 78). With this approach, the measuring accuracy of the unloads can be improved by taking the most stable weights when they become available.

In real-world conditions, it is possible that the grain cart 14 may not stop moving long enough between unloads to get stationary weights for both the start and stop weights in all settings. To address this, the pre-unload and post-unload average weights can be used as a backup for determining the unload weight in case the stationary load weights are not available for the unload. The unload information is recorded with the start and stop weight method (stationary or averaged). Based on the unload weight method, the calibration system 10 can determine how to apply the corresponding recorded calibration load profile to the calibration process. In certain implementations, the system 10 is configured to give calibration load profiles with more accurate unload weights more influence in the calibration process.

Weighing system accuracy may also be dependent on grain cart orientation (tilt, roll and/or pitch, as is shown in FIG. 2A at box 74). Accordingly, the calibration system 10 according to certain implementations can be equipped with a sensor 30 (e.g an inertial measurement unit or tilt sensor) to provide tilt, roll and pitch (box 74 in FIG. 2A) so that grain cart roll and pitch can be determined. Knowing the roll and pitch of the grain cart during weight measuring allows the calibration system 10 to determine the accuracy of the measured unload weight. This information can be used to, for example: reject unloads and their corresponding calibration load profiles if the grain cart orientation is not appropriate for weighing, determine how much influence a recorded calibration load profile (based on the unload) has in the calibration process, allow measured weights to be adjusted if the orientation effects on the weighing system are well known and a reliable adjustment algorithm can be determined and other uses that would be readily apparent to those of skill in the art.

Unload Validation. Unloads need to be validated (see, e.g., box 83 in FIGS. 2A-2B) before they are assigned to calibration load profiles. In one implementation for a calibration system 10, the weight information from the grain cart is transmitted to the combine over a wireless data link 16. Some unloads occur directly to grain trucks or other non-instrumented grain carts. This means that the system observes that an unload is occurring, but the weight of the unload cannot properly be recorded. In this case, the calibration system 10 would register that an unload is occurring and starts the “record-unload” process. During the unload, the grain cart weight is being received, but is not increasing. The resulting unload is measured as 0 or a very small amount.

According to certain implementations, the calibration system 10 is either configured to be set to an expected unload rate (such as on the basis of user-inputted or stored data) or has established the desired unload rate by monitoring the increase in grain cart weight over time, as would be appreciated. Based on the time the unload auger was determined to be running and before the grain tank was determined to be empty, the combine should have unloaded an amount of grain close to the expected value based on the unload rate. If the recorded unload weight differs from the expected unload weight by more than the unload acceptance threshold, the unload is rejected, and the calibration load profile associated with that unload is deleted from the system.

In certain field conditions, the calibration system 10 receiving the grain cart weighing system weight can lead to invalid unloads being recorded (see, e.g., box 86 in FIG. 2A). For example, in implementations that uses the wireless data link 16 to transfer the grain cart weight from the weighing system 31 to the combine 12, radio frequency interference may prevent the calibration system 10 from receiving the weight during an unload event. This can lead to either invalid or unknown unload weights that are detected and rejected by the system 10 and not used, as would be understood.

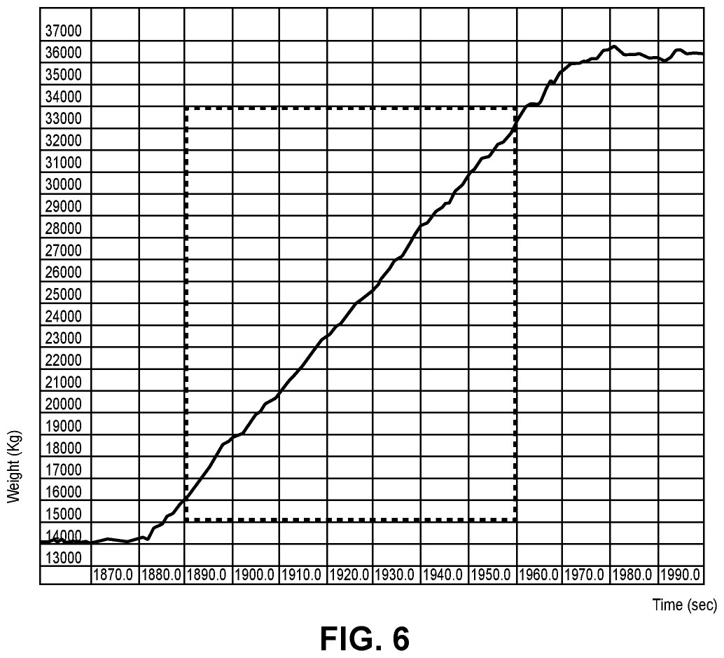

Continuing with the drawings, FIG. 6 depicts the unload of corn from a John Deere S770 combine as measured by a grain cart weighing system. In the region highlighted by the dotted line, the starting weight as 16,140 kg at 1890 seconds and the ending weight as 33,240 kg at 1960 seconds. This is an increase of 17,100 kg over 70 seconds, which equates to an unload rate of 244 kg/sec.

It has been observed that estimating unload weight based on the unload auger being engaged requires an algorithm that includes a delay as the unload auger is engaged, followed by a ramp-up period as the unload auger is filling. Once the unload auger is filled, the unload remains fairly steady until the combine grain tank nears empty at which point the unload rate begins to taper off until the unload auger is emptied. If unloading is stopped before the combine grain tank is empty, the unload rate stops more abruptly. The unload delay and ramp-up time may be entered as a setting or determined by monitoring the unload status and grain cart weight. Once the parameters for the unload estimation algorithm have been determined, the unload weights are estimated based on the timing of the unload auger engagement. The unload estimated weight is compared to the recorded unload weight for validation.

Detecting Unload State Without Unload Sensor. The calibration system 10 in certain implementations can also be run without an unload auger sensor or by receiving the unload auger state from the vehicle CAN bus. In these implementations, unloading is detected by monitoring the weight data from the grain cart weighing system 31. When the combine starts unloading, the weight of the grain cart will begin increasing, usually at a roughly linear rate that matches the unload rate of the combine. Detecting unloading is therefore a function of the weight increase and the linearity over a set time period, and linearity is measured by how closely the weight increase follows a linear increasing line. Measuring the linearity of the weight can require that the grain cart weight samples to be buffered over a set time period. Further, detecting linearity always occurs after unloading has actually started and data is being recorded. Thus, the system can be configured to account for an unload start detection delay, which can typically equal or approximate the linearity buffer time. When the calibration system 10 detects unloading with the weight increase, it will use the buffered grain cart weight data to establish the correct unload start weight by accessing the weight data collected at time points before unloading started and averaging the data to establish an accurate unload start weight.

Once unloading is detected, the system 10 mode changes to detecting when unloading has stopped. Detecting when unloading is stopped is also a function of the weight increase and linearity over a set period of time. When the calibration system 10 detects that unloading has stopped (or is stopping), there is typically a small amount of grain still to be added to the grain cart. Thus, the determination of stop weight for the unload needs to be delayed. This is the unload stop detection delay. Also, because sampling noise of the grain cart weighing system can result in noise (variation over a small range) in the measured weight of the grain cart, the stop weight will need to be averaged over a number of samples in certain implementations to reduce the effects of the noise and produce a more stable weight in certain implementations. This occurs after the unload is estimated to have stopped. The total delay until the unload stop weight is determined then by the unload stop detection delay plus the sample averaging delay. Other approaches are of course possible.

Linear Correlation. In certain implementations of the system 10, a linear increasing correlator (LIC) mathematical function is used to determine if the grain cart is being unloaded to. The LIC examines the grain cart weight samples over a period of time starting with the last-received weight sample. One implementation uses the previous ten seconds of weight samples, though other durations are of course possible. The minimum weight and maximum weight are determined for the weight samples by comparison. The weight increase is measured as the maximum weight minus the minimum weight. If the weight increase measured for the period does not exceed the minimum weight increase expected, no unload is detected.

The minimum weight increase expected is based on the expected unload rate of the combine, as defined. If the weight increase matches or exceeds the minimum weight increase expected, the LIC calculates the expected sample weights by using the straight line between the minimum and maximum sample weights over the period. The sample error is determined as the actual sample weight minus the expected sample weight, this value divided by the weight increase to normalize the values based on the weight increase. The LIC calculates a linear error score as the square root of the sum of the squared sample errors, as shown in Eq. 1, below.

In certain implementations, the Linear Error Score Equation is given as:

$${E}_{L} = \sqrt{{\sum }_{N = 1}^{N = w} {( \frac{{W}_{A} - {W}_{E}}{S} )}^{2}} , where : \qquad ( Eq . 1 )$$

E_{L}=Linear Error Score
W_{A}=Actual Weight
W_{E}=Expected Weight
S=Weight Span for the period (Maximum Weight minus Minimum Weight)
N=Weight Sample Index
w=Number of Samples in Linear Measurement Buffer

In one example implementation, unloading was detected when the weight increase value was greater than or equal to 1,500 lbs and the linear error score value was less than 0.75. When an unload was active, the unload was active until the weight increase value was less than 750 lbs. or the linear error score value was greater than 1.0. It is readily appreciated that further weight increase and linear error score values can of course be utilized.

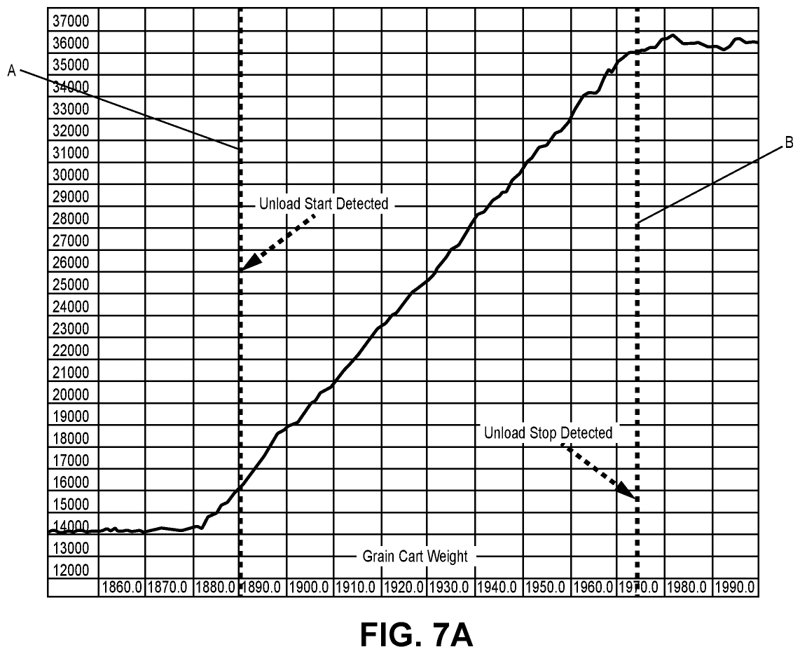

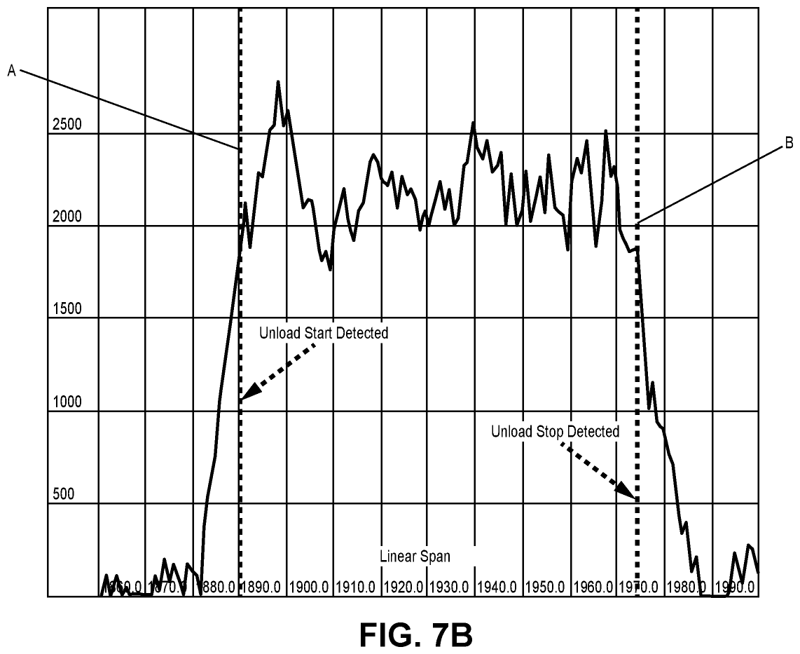

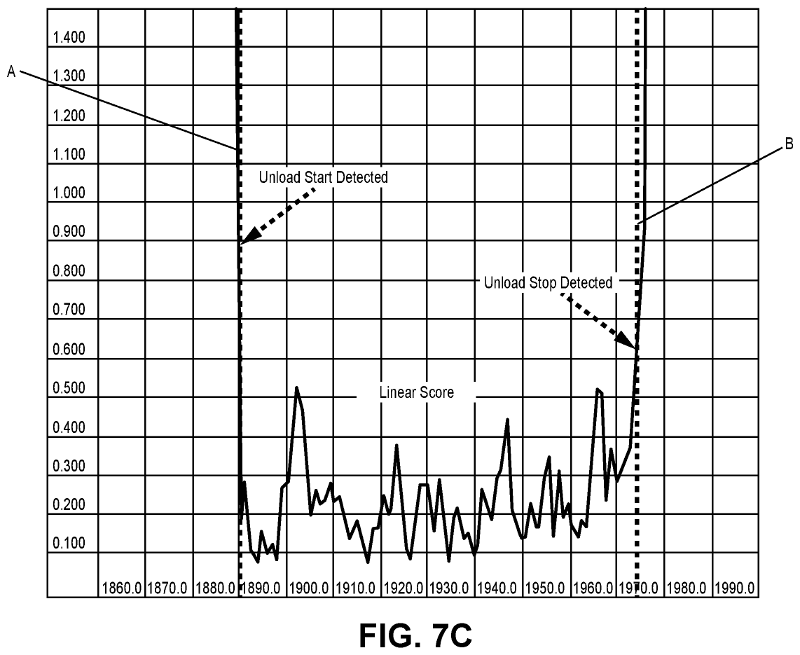

FIGS. 7A-C depict an example of grain cart scale weight (FIG. 7A) during an unload synchronized with a linear span (FIG. 7B) and linear score (FIG. 7C) algorithm using a 10 second buffer. The grain cart weight is shown in pounds. The unload start detection from the LIC is shown as the vertical dotted line marked A. As is shown in FIG. 7A, the grain cart weight graph, unloading started approximately 10 seconds prior to detection, just after 1880 seconds). This is the unload start detection delay, and is expected, as the buffer size corresponds to 10 seconds of sampled data (unload start detection delay=10 sec). The unload stop detection is shown as the vertical dotted line on the right of FIG. 7.

The grain cart weight graph (FIG. 7A) also shows that unloading does not actually stop until about 7 to 10 seconds (1980 seconds) after stop detection (shown at dashed line B). This is the unload stop detection delay. This is expected because unloading tapers off as the combine grain tank empties. By using unload start detection delay, unload stop detection delay, and buffered grain cart weight averaging, the unload start weight is determined to be 14138 lbs. and the unload stop weight is determined to be 36553 lbs. for a total unload weight of 22415 lbs.

Using Grain Truck Weight Information to Improve Grain Cart and Yield Monitor Calibration. Certain implementations of the system 10 are configured to utilize a comparison of recorded grain cart 14 weight information (which in certain implementations is derived by measuring secondary grain truck weights) which can in turn be compared with the estimates of recorded calibration load profiles to calibrate the system (box 94) through a variety of processing (shown generally at box 83 in FIG. 2A-B) and/or corrections (box 96) steps and approaches. These linear correction (box 96) approaches are presented herein as exemplary, and can of course be adapted and altered as would be readily appreciated. These correction (box 96) approaches relate generally to the comparison of measured grain cart 14 weight at various points along the fill cycle with the corresponding estimated weight provided by the system 10 and yield monitor 28, and then the application of mathematical approaches to detect deviations between actual weight and estimated weight and subsequently reduce those errors in the calibration of the system 10 through the application of corrections (shown, for example at box 96 in FIG. 2B). That is, as discussed herein, the measured weights from the grain cart 14 are compared with estimated weights from several recorded calibration profiles to process and correct those calibration profiles for use in improving the calibration of the system.

In use according to certain implementations, it is possible that the calibration system 10 may start in a state where neither the yield monitor 28 nor grain cart weighing system 31 has been properly calibrated. If the grain cart weighing system 31 has not been calibrated, the yield monitor 28 may eventually be calibrated to the grain cart weighing system 31, but would not be calibrated to the terminal scale used for measuring the actual weight of grain being stored or sold, such as via one or more grain trucks. To address this issue, the calibration system 10 can be configured to track the weight added to grain trucks for the purpose of utilizing grain truck measured weight to improve the grain cart and yield monitor calibration. It is further appreciated that this information can be incremental, that is, consisting of several successive loaded trucks with the data points tracked as sessions with, optionally, defined start and stop weights, as would be appreciated.

In the example shown in FIG. 8, the grain cart 14 weighing system 31 linear calibration is off by 5% (the solid line measured weight is 5% greater than the dashed line showing the actual weight) as compared with the ground truth measured weight as established by a terminal scale (shown, for example, at box 95 in FIG. 2A). If the estimated weight is compared with the measured weight (ground truth, box 95) by a terminal scale, the measured weight from the terminal scale will thus be 5% less than the weight measured with the grain cart weighing system 31.

If the measured weight ground truth (box 95) of the terminal scale is thus entered into the calibration system 10, the calibration of the grain cart 14 can be adjusted as an applied correction (shown at box 96) such that the estimated weight derived from the grain cart weighting system 31 or calibration load profile can be calibrated to match the terminal scale measured weight. If the weight data (box 66), unload start (box 68) and/or stop weights (box 78) are recorded for all the unloads, they can be corrected according to the new calibration. The calibration system 10 then uses the updated unload weights to update the calibration load profile actual weights and, in turn, update the yield monitor 28 calibration. Thus, the yield monitor 28 is now calibrated to the terminal scale, which is desirable because the terminal scale is the one used for measuring the amount of corn sold or stored.

FIG. 8 is an example that illustrates how the grain cart 14, weighting system 31 and yield monitor 28 can be calibrated to the terminal scale by also tracking truck weight ground truth from a terminal, optionally in sessions. Some grain cart weighing systems have functions that allow tracking the weight of grain loaded to grain trucks or other secondary transport vehicles. The problem for the calibration system 10 is that the weights recorded assume the grain cart is calibrated and weighs grain in a perfectly linear way over the weighing range. Although most grain carts use a linear calibration factor (and assume a linear weighing response), the actual weight response over the measuring range may not be perfectly linear. A non-linear response in a grain cart weighing system 31 can introduce error in the calibration system 10. This results in reduced accuracy for the yield monitor.

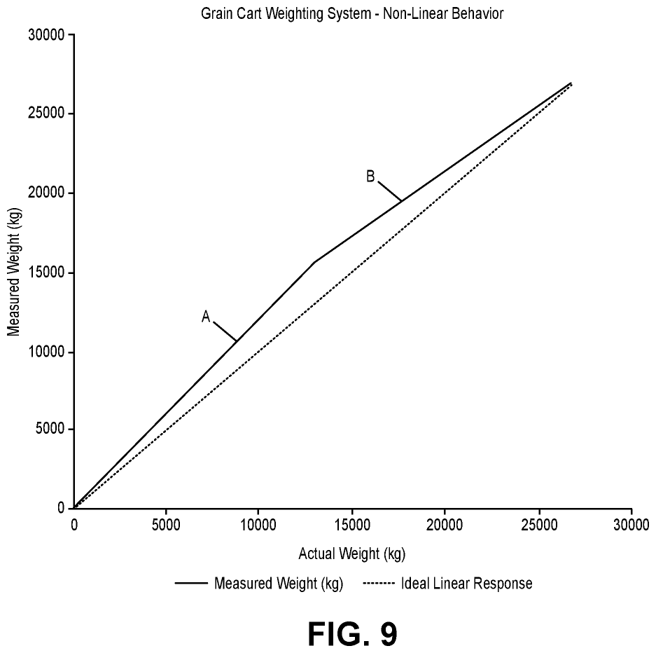

FIG. 9 is an example of a grain cart weighing system that has non-linear behavior in its sampling range. For a load transfer from the grain cart 14 to the grain truck for measurement for example, via a terminal, if the measured weight (solid line) between starting and stopping weights along the measured weight function according to the grain cart weight system 31 is not parallel to the ground truth actual weight function (dashed line), the measured weight for the grain unloaded to the truck will have error. For each load transfer to the grain truck, if the starting (box 68) and stopping weights (box 78) are tracked, and then compared with the truck weight measured by the terminal scale (ground truth, box 95), it is possible to calculate the measurement response of the grain cart weighing system 31 versus the actual weight, which can be used to define the calibration for the grain cart.

For the graph shown in FIG. 9, if for example the load transfer start (box 68) weight is 21,400 kg and the stop weight (box 78) is 6,000 kg. This equates to a measured load transfer of 15,400 kg. In this example, however, the grain truck load weight (ground truth, box 95) measured on the terminal scale is 15,000 kg. The grain cart weighing system has measured the weight 400 kg higher than actual (˜+2.7%). A second load transfer is measured with starting weight of 17,400 kg and stop weight of 3,600 kg (load transfer=13,800 kg). The grain truck load weight was measured as 12,000 kg.

If the weighing system response is modeled as bi-linear, it is possible to estimate the weighing response with two linear sections along the weighing range (shown at A and B). In this case, it can be assumed that the weighing system has been calibrated when full (27,000 kg). It is assumed that the weighing response is accurate at 0 and the full calibration point (27,000 kg). To simplify the presentation of the concept, it is possible to set the bi-linear split point as half of full (13,500 kg) and utilize the recorded load transfer start and stop weights along with the recorded truck weights to estimate weighing system response at the bi-linear split point to set the slope of each linear section. Here, the value is set to reduce the amount of error between the estimated load transfer weights and the actual load transfer weights. In the case of the load transfer described above (Start Weight=21,400 kg, Stop Weight=6,000 kg, Terminal Scale Weight=15,000 kg), the measured weight (y) at the mid-point (x=13,500 kg) is determined to be 15,000 kg. We can now use the two linear sections (A & B) that represent the weighing system response to determine the relationship between grain cart measured weight and actual weight and correct the weights for the combine unloads that are then used to calibrate the yield monitor.

A bi-linear approximation illustrates the concept, but more complex approaches may be used, including the use of more linear sections across the weighing range. Calibrating the grain cart in a non-linear fashion then becomes very similar to how the yield monitor is calibrated where the calibration numbers (for the linear sections) are adjusted iteratively to reduce the amount error between estimated weight and actual measured weight for the load transfers.

Improving the Grain Cart Weighing System Calibration via the Calibration System. In various implementations, the performance of the grain cart weighing system 31 can also be improved via calibration (box 94) of the grain cart weight system 31. Most grain cart weighing systems 31 used in harvesting operations utilize only a single calibration number and assume linearity through the sampling range. Harvest grain cart weighing systems are typically calibrated at or near the volume capacity of the grain cart. The weight that the measuring system is calibrated at is called the calibration point.

Some grain cart weighing systems 31 have non-linear behavior throughout their sampling range. A simple non-linear behavior a grain cart might exhibit is where the weighing system reports more weight than actual increasing from 0 to a break point somewhere in the sampling range. The percent error from actual weight increases from 0 to the break point. The weighing error, as a percent, is at its maximum at the break point. From the break point to the calibration point, the weighing error decreases until it reaches the calibration point. Ideally, the weighing system 31 would be calibrated at multiple points throughout the sampling range and can utilize those points to provide a more accurate weight across its range.

When the grain cart-measured start (box 68) and stop (box 78) weights are recorded with the combine unloads, which are tied to the calibration load profiles, the calibration system 10 can analyze the calibration load profile and unload data and detect non-linear weighing behavior from the grain cart 14. The system 10 according to these implementations can also estimate the non-linearity of the grain cart weighing system 31 and calculate and apply its own calibration to the grain cart weight to produce a more accurate unload weight across the sampling range via updating the calibration (box 94).

Consider an exemplary harvesting operation where the combine grain tank has approximately half the capacity (volume/weight) of the grain cart used to unload and transport the grain from the combine to the grain trucks or other over-the-road transport vehicles. The typical operating procedure would be to harvest until the combine grain tank is near capacity (or about half the grain cart capacity), then unload the grain to the grain cart. The combine would continue harvesting until the combine grain tank is again full. The grain cart, which is approximately half full, would then receive the unload from the combine grain tank and be near full. The grain cart would then proceed to a grain truck (or other transport vehicle) and unload the grain it has received during the two unload operations.

FIG. 9 illustrates an exemplary example of a grain cart weighing system 31 that has non-linear behavior in its sampling range, showing the measured weight (solid line) and the ideal linear response (dashed line). For this example, the weighing system has been calibrated when the grain cart is full at approximately 27,000 kg. Therefore, the error at that point is 0, and 27,000 kg is the calibration point. For this example, assume that the measuring error at 0 kg (empty) is also zero. In this example, the actual weight of grain in the grain cart increases relative to the ideal linear response from 0 to 13,000 kg, such that the measured weight (solid line) is reported as more than the actual and reaches its maximum deviation value at approximately 13,000 kg, which thus represents the break point. From the break point (13,000 kg) to the calibration point (27,000 kg), the difference between measured weight and actual weight decreases until it reaches 0 at the calibration point (27,000 kg). While the actual measuring behavior is non-linear, in this example it is possible to approximate the measuring behavior as two linear segments of differing slope, which meet at the break point.

In this example, the grain cart weighing system 31 has two ranges, a lower range from 0 to the break point, and an upper range from the break point to the calibration point. If we measure an actual 5000 kg load in the lower range, the measured weight will be higher than 5000 kg. If we measure an actual 5000 kg load in the upper range, the measured weight will be lower than 5000 kg.

If the grain cart weighing system has the non-linear weighing behavior as shown in FIG. 9, the measured unload weight of the first load would be more than actual, while the measured unload weight of the second load would be less than actual. The total weight would be accurate because the grain cart was calibrated at capacity. If both loads were valid calibration loads, the system would produce a calibration that was fairly accurate because it split the difference between the two loads where the first load has positive error because it estimated more weight than actual, while the second load had negative error because it measured less weight than actual. This case is an ideal (and unrealistic) case where the calibration loads always occur in two distinct ranges over the sampling range of the grain cart weighing system. The reality is that unloads will likely occur over the full range of the weighing system. By recording grain cart start and stop weight, it is possible to analyze where each load is in the range of the grain cart weighing system and compare the calibration load profile errors to the load range. In this example, loads in the low range mostly had negative error while loads in the high range mostly had positive error.

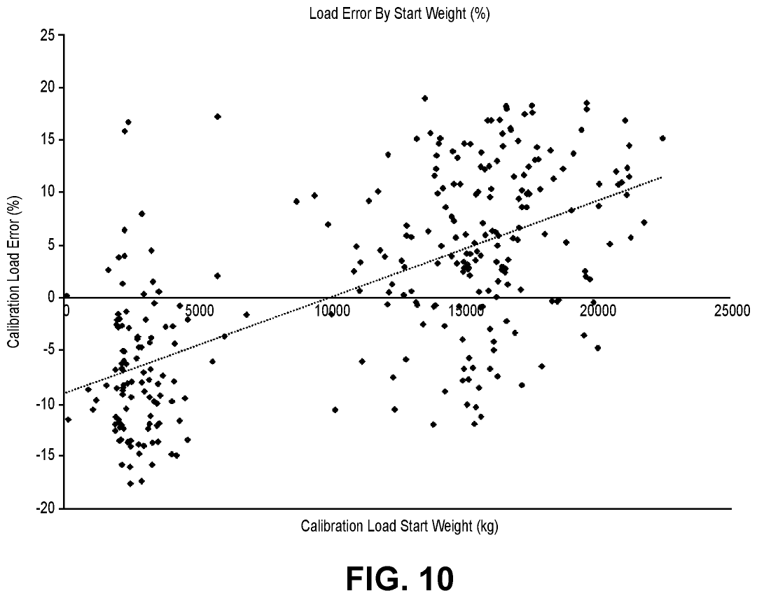

FIG. 10 is a scatterplot example of actual corn harvest data showing on the x-axis the calibration load start weight (box 68 in FIG. 2A) from the grain cart weighing system 31 versus the precent calibration load error on the y-axis. Calibration load error is the difference between the estimated load weight (using the calibration) and the actual load weight as determined by the grain cart weighing system 31. Again, in this example the lower measuring region was defined as 0 to 13,000 kg whereas the upper measuring region was defined as greater than 13,000 kg. The calibration loads on the left side of the graph are generally in the lower measuring region (below 0%) while calibration loads on the right side of the graph are in the upper measuring region (above 0%). In this case, the calibration load profile can corrected (box 96) so as to be based on all the calibration loads across both regions. It can be observed that nearly all the loads in the lower measuring region have negative error, while most of the loads in the upper measuring region have positive error.

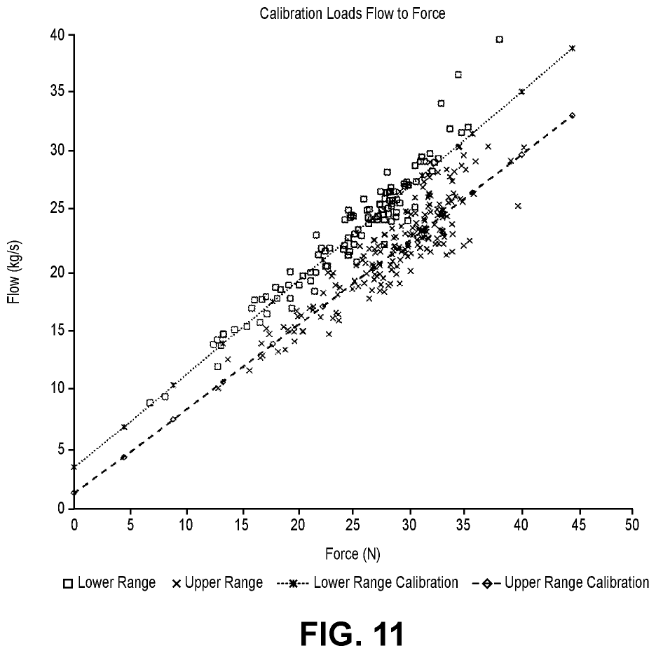

FIG. 11 depicts the same recorded calibration loads but now graphed for average flow (y-axis) versus average force (x-axis). Graphing average flow versus average force is not a true representation of the calibration loads, but it provides a reasonable approximation that allows us to visualize the concepts being presented. FIG. 11 demonstrates that most of the lower range (boxes) calibration loads are grouped in a linear fashion above most of the upper range (x-es) calibration loads. This illustrates that the measuring range for the calibration load is influencing how they are being measured. If a calibration is done using only the lower range loads, that is illustrated by the dotted line in the graph in FIG. 11.

A calibration done using only the upper range loads is illustrated by the dashed line in the graph in FIG. 11. The difference between these calibrations represents the measuring error between the lower and upper measuring regions. Applying these calibrations to all the loads shows that the percent error between the regions is 14%. If we assume that 13000 kg represents a break point and 26,000 kg is the calibration point, we can develop a formula for adjusting the measured grain cart weight, so it more accurately reflects actual weight. That is, via system 10 processing and verification of calibration load profiles recorded at different points in the measuring region, calibration can of the yield monitor 28 can be calibrated using these techniques.

This is essentially another level of calibration above the grain cart weighing system internal single-point linear calibration. Approximating the break point error as half the error between the lower and upper calibrations, certain implementations of the system 10 use the following formula to correct the grain cart measured weight, as follows, here 13,910 is the estimated measured break point, 0.935 is the estimated observed lower region correction and 0.075 is the estimated observed upper region correction (box 96):

For Wmea>=0 and Wmea<13,910 kg: Wadj=Wmea*0.935

For Wmea>=13,910 kg: Wadj=Wmea−0.075*(Wcal−Wmea)

### Where:

Wmea=Measured Grain Cart Weight (kg)
Wadj=Adjusted Grain Cart Weight (kg)
Wcal=Grain Cart Calibration Weight (kg)

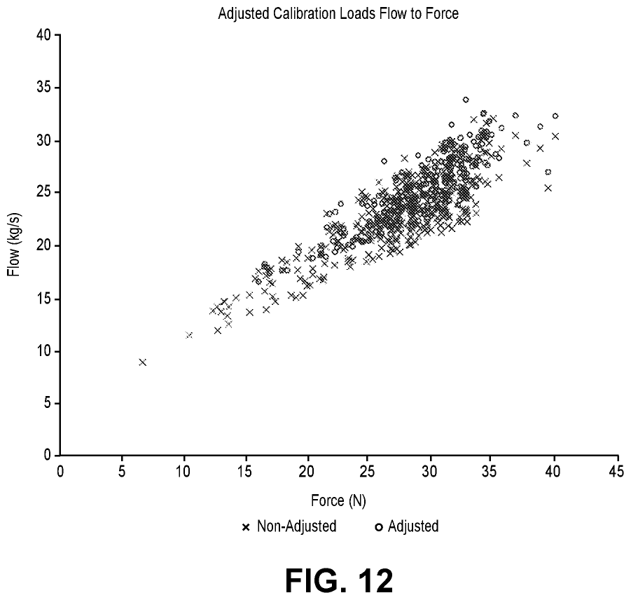

FIG. 12 illustrates the application of the grain cart weight adjustment formula correction to the grain cart weights used in the example data set of FIG. 11. The unload start (box 68 in FIG. 2A) and stop (box 78) weights were adjusted and new unload weights were applied to the series of calibration load profiles. A new calibration was calculated based on the updated data. With the non-adjusted data set, the total error of all the calibration loads was 7.6%. After system 10 processing (box 83), the total error of all the calibration loads was 4.9%, an improvement of 2.7%. Further improvements are of course possible with additional iterations by the system.

In FIG. 12, the reduction in error is seen as the tighter grouping of the adjusted calibration loads as compared to the non-adjusted calibration loads. Calibration load error is the difference between the estimated weight of the load, using the calibration, and the actual weight of the load, as recorded using the grain cart weights. The total error, in percent, is the sum of the absolute value of the calibration load profile errors, that sum divided by the sum of the calibration load actual weights (using the grain cart weights).

The description above for calibrating the non-linearity of the grain cart assumes that the system 10 has been calibrated with the grain cart at full capacity. This is not a requirement for being able to measure the grain cart's non-linearity. If empty (weight=0) is a calibrated point, any other point along the measuring range could be used for calibration, so long as it has enough distance from the zero point (in the measuring range) to minimize measurement noise to an acceptable level. It is possible that the grain cart scale has not been calibrated at any weight. If the combine yield monitor 28 is properly calibrated to the grain cart weighing system 31 or scale, which is not calibrated, it would still be possible to determine the non-linearity of the grain cart scale using the same method described above that tracks start and stop weight of each recorded calibration load profile. Without a second calibration point, however, it's likely all linear ranges across the entire range of the grain cart scale will be inaccurate when compared to the calibrating scale. If the grain cart weight calibration methodology described above in relation to FIGS. 9-12 is used to calibrate the grain cart, the grain cart linear calibration can be determined and the non-linearity calibration can then be applied to fully calibrate the grain cart weighing system.

While the example illustrated a bi-linear method to measuring and compensating for the error of the grain cart weighing system, more complex methods may be used including using more measuring ranges as well as mathematical analysis across the entire sampling range to characterize the non-linearity.

Manually Calibrating the Grain Cart Weighing System using Multiple Points. While the previous section described how to use the calibration system 10 calibration load profile data to measure the non-linearity of the grain cart weighing system, the calibration system 10 may also include a method where the grain cart weighing system 31 is calibrated over the entire weighing range using multiple calibration points as points of correction (box 96). In one such implementation, a secondary scale—which is also calibrated for accurate weighing—is used to measure the weight of the grain cart (and optionally its towing vehicle).

In such an implementation, this scale represents the “actual” weight of the grain cart and allows the grain cart weighing system measured weights to be correlated to actual weights. The calibration process starts with establishing a baseline weight using an empty grain cart. Next, the grain cart is filled to some level. The grain cart weight is recorded to the calibration, along with the weight measured by the secondary scale. The weighing process is repeated for a distribution of checkpoints across the weighing range. The array of checkpoints that correlate measured weight to actual weight allow the calibration system 10 to adjust the measured weights reported by the grain cart weighing system to more accurate values. The calibration system 10 can then use these adjusted weights for the calibration load profiles to produce a more accurate yield monitor 28 calibration and/or grain cart weight system 31 calibration.

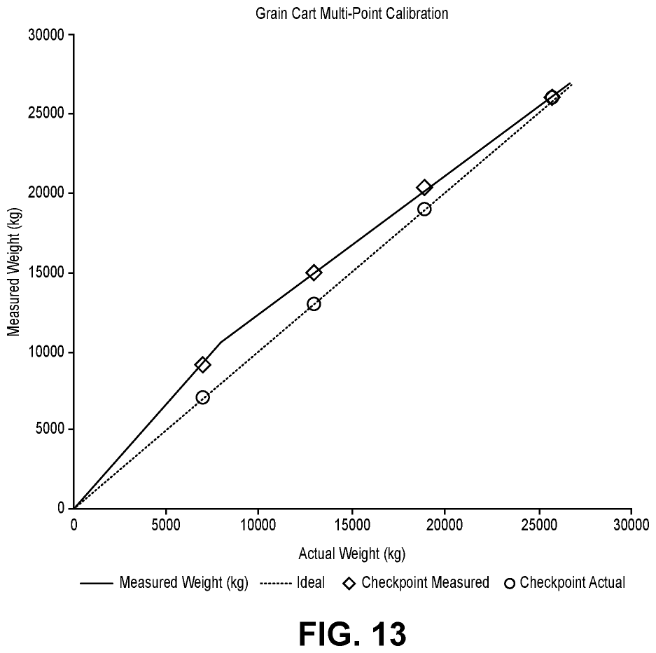

FIG. 13 is an illustration of non-linear grain cart weighing and the application of a multi-point calibration to improve weighing over the sampling range, according to these implementations of the system 10. Adjusting the grain cart weight would be done by linear extrapolation between the two nearest calibration points to the measured weight.

Limiting Calibration Load Profiles to Accurate Grain Cart Weighing Range. Because of the non-linearity of many grain cart weighing systems 31, it may be advantageous to limit the calibration system 10 to a defined measuring range to produce calibration load profiles. For example, if the grain cart was calibrated to the typical amount for a full combine grain tank, the weighing range from 0 to the calibration point likely will produce better linear measuring than if the grain tank were calibrated at full capacity. If the calibration system 10 is configured such that it only selects calibration loads which have unloads in the calibrated range (e.g., a single combine grain tank) the calibration will likely be more accurate than using the full range of the grain cart weighing system 31.

In this example, the lower range data set in FIG. 11 are calibration loads where unload occurred in the lower range of the grain cart weighing system. When just these loads were calibrated, the total error came out to 4.3%, which is 3.3% better than the total error observed (7.6%) using all the calibration loads across the entire sampling range. If the grain cart weighing system had been calibrated at the lower weighing range, this likely would have produced a more accurate calibration.

Limiting Calibration Load Profiles to Full Grain Cart Weighing Range. If the grain cart weighing system is calibrated at full weight and has a non-linear response in its weighing range, it may be desirable to only create calibration load profiles based on a full grain cart. This is because weighing at or near the calibration weight is more accurate than weighing at some intermediate weight. It would be expected with this strategy that the grain cart capacity would be some multiple of combine grain tank capacity. For example, suppose the grain cart capacity is approximately two times the combine grain tank capacity. This would mean that the combine grain tank could be filled and then completely emptied to the grain cart twice. If calibration loads were only started when the grain cart was full and the combine grain tank was empty, each calibration load would constitute one grain cart load or two combine grain tank loads. Because the calibration load weighing occurred at or near the calibration point, the weighing error due to non-linearity in the grain cart weighing system is reduced.

Strategies for Determining Grain Cart Starting and Stopping Weights. There are a number of factors that determine how a grain cart weighing system 31 will actually measure the load weight. These factors can include load distribution within the grain cart, roll (left/right position from level to the earth), pitch (fore/aft position from level to the earth), and motion effects (velocity and terrain condition), as described above. The system 10 according to certain implementations is able to utilize a variety of sensors and approaches to calibration.

One way to accurately measure a load of grain within a grain cart is to position the grain cart (and towing vehicle) on level ground so the roll and pitch of the grain cart are at or near zero. The grain cart is stopped for a short period of time to eliminate any residual motion or vibration and then the measured weight of the weighing system is recorded. In real harvest scenarios, it is usually impractical to require the grain cart operator to find level ground and stop to take a weight measurement for starting (box 68) and stopping (box 78) weights. Harvesting can often be a fast-paced operation and the efficiency of the operation may depend on how quickly the grain cart can receive grain from combine, transport and unload it to waiting grain trucks, and then return to the combine for the next unload. Time delays for weight measuring may slow down the harvest operation, which is undesirable. Thus, the grain cart is often in motion when unload starting (box 68) and stopping (box 78) weights need to be determined. That is why the implementation presented uses an average weight over a given duration (as is collected for example at box 80 in FIG. 2A), such as 10 seconds in determining the unload starting (box 68) and stopping (box 78) weights.

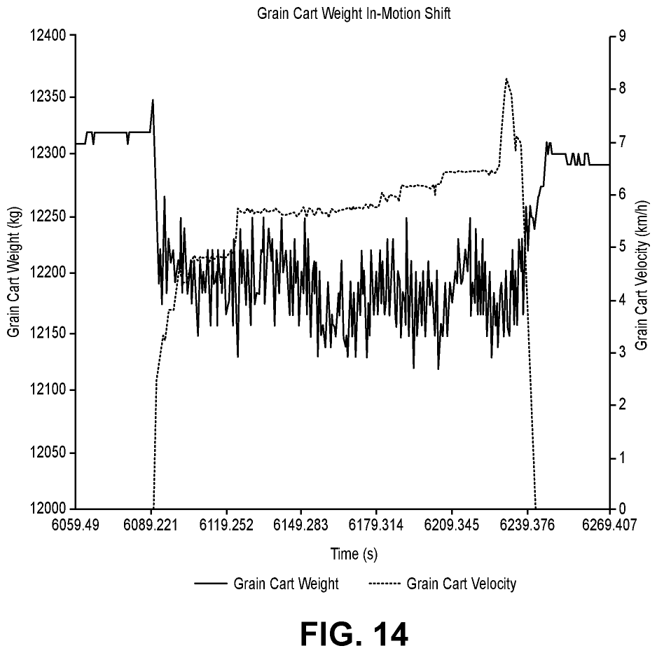

It is known through experience that motion of the grain cart introduces signal noise in the measured weight reported by the weighing system. FIG. 14 illustrates the measured weight of a grain cart weighing system as the grain cart is put in motion and then stopped. It is observable that as the motion is started, the stable signal drops and begins to exhibit noise (random variability). When the motion stops, the measured weight noise decreases until the measured weight again stabilizes. Further, the stable weight before motion is slightly different than the stable weight after motion (about 190 kg or 1.2%). This is likely due to changes to the weighing configuration. The in-motion effect of the measured weight being less than the not-in-motion “stable” weights has been observed with a number of grain carts. Consequently, this in-motion weighing shift must be considered with the calibration system 10 where grain cart weighing may occur while in-motion or stationary.

If a grain cart weighing system 31 exhibits in-motion signal shift and weighing an unload is started with the grain cart in motion, but the unload is completed when the grain cart has stopped, this can introduce error in the measurement. Likewise, if the unload starts when the grain cart is stationary, but stops with the grain cart in-motion, that can produce error in the measurement due to the in-motion signal shift.

The calibration system 10 according to certain implementations is adapted to monitor grain cart weight and speed, as well as other factors like roll and pitch the implementation of a grain cart weighing profile. The grain cart weighing profile determines certain grain cart characteristics such as detecting in-motion signal shift, measuring noise for stable weights, measuring noise for in-motion weights, and measuring effects of roll and pitch to determine how well the grain cart system is measuring the grain cart's load and use that information with the calibration system 10 to, for example: reject unloads and calibration load profiles where weighing system accuracy is not acceptable for accurate performance. This may include rejecting loads where the start weight was collected in-motion and the stop weight was collected stationary, and vice-versa; utilize weighing system accuracy information in the calibration process to determine how the associated unloads (and calibration load profiles) affect the overall calibration. Accurate loads would affect the calibration more so than less accurate loads; and/or if in-motion signal shift is known for the grain cart—correct unload start or stop weights if the load started in-motion and completed while stationary or the load started stationary and completed while in-motion.

Calibrating Based on Crop Conditions.

It has been observed with impact force-measuring yield monitors that crop moisture can affect the force imparted to the measuring device (load cell). This causes variability in measuring corn yield with the yield monitor using a single calibration. Corn is a crop that is often harvested when the moisture level in the grain is still high. As the harvesting operation continues over several weeks to a few months, the corn continues to lose moisture and becomes drier. A yield monitor calibration tailored to high moisture corn may not be appropriate for accurately measuring low moisture corn. Some yield monitor systems have utilized two different crop types for corn, so it was possible to have calibrations that were more accurate for corn within a specific moisture range. Dealing with moisture effects in corn shows why there is a need for a calibration system. With a manual calibration system, the operator is required to do two manual calibrations (one for each moisture range). Manually calibrating takes time and slows the harvest operation, something that is considered undesirable. On top of that, the operator must make sure that the right crop type (and calibration) are selected for the current crop moisture. This, too, creates a burden for the operator to constantly monitor and update the system appropriately.

With a calibration system 10, multiple calibration load profiles can be created based on a measurable crop condition, such as moisture or other identified crop conditions, for use in calibrating the yield monitor 28 and system 10. Further, it is understood that the system 10 allows calibration profiles to be stored for later use. For example, the calibration system 10 can be configured to create low-moisture and high-moisture corn calibrations based on the crop moisture being above or below 17% (as an example). Once there are calibrations based on moisture range, the calibration assigned to a harvest load is now based on the average moisture for that harvest load. This happens automatically, without the operator needing to switch crop types or calibrations. Although the example here describes using two ranges for a crop condition (moisture), a calibration system 10 may use more than two ranges for calibrating based on a crop condition.

Although it has not been extensively studied, there may be other crop conditions than just moisture that affect the way the impact force is measured by the yield monitor and thus create variability across a single crop type. These may include, but are not limited to, the test weight of the crop (mass per volume) as well as the size and shape of the kernels. If different crop varieties produce different test weights and kernel sizes, there may be variability when measuring with the yield monitor. Using a calibration specific to the variety may produce more accurate results than using a single calibration across all varieties.

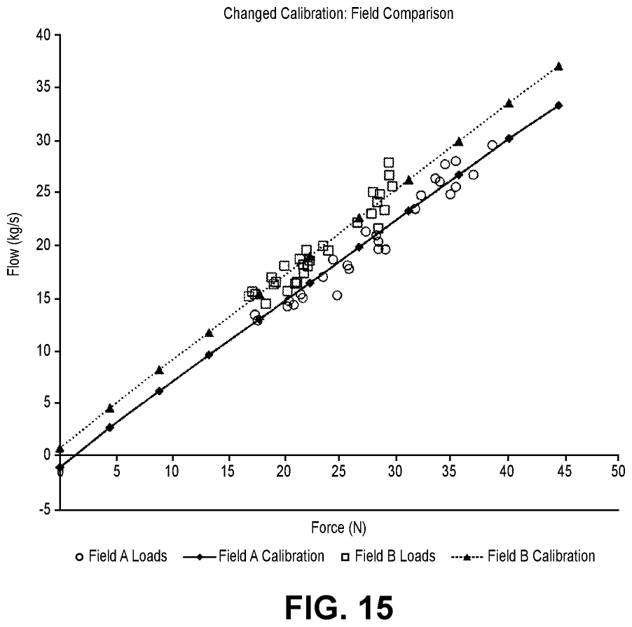

FIG. 15 illustrates the impact on yield monitor 28 calibration due to changes in the measuring characteristics. In FIG. 15, harvest loads for two fields, Field A and Field B, are shown with average flow versus average force. The loads for Field A are denoted by circles whereas the loads for Field B are denoted by squares. We can observe in comparing the Field A and B loads that the Field B loads are generally producing a higher flow to force ratio. This is an indication that the crop measuring conditions have changed from Field A to B and a new calibration should be used. This becomes obvious when we examine the calibrations for each field that were derived using only the loads in each field. If we use a single calibration for the loads in both fields, the resulting error and variability is higher than if we use different calibrations for each field. The error is defined as the summation of the absolute value of the difference between measured weight and actual weight for each load, that number divided by the total actual weight of all loads.

| Field | Calibration | Error |
|---|---|---|
| Field A | Combined | 8.3% |
| Field A | Field A | 4.8% |
| Field B | Combined | 6.8% |
| Field B | Field B | 4.5% |

Various implementations of the calibration system 10 described may utilize the Bin Sigma score for the calibration load profile as one of the factors for evaluating whether the given calibration load profile is acceptable for use. A Bin Sigma threshold is defined such that calibration loads with a Bin Sigma lower than the threshold will be marked as “acceptable” and available for use in determining the yield monitor 28 calibration. Calibration loads with a Bin Sigma higher than the acceptance threshold will be rejected and not used for calibrating the yield monitor. For example, the Bin Sigma threshold may be set to 15, which means that any load with a Bin Sigma of 15 or higher will not be included in calibrations. The Bin Sigma threshold may be a user setting, configured by the operator or a system setting configured by the calibration system 10.

The combination of Bin Max and Bin Sigma may be used to determine the best loads to select for yield monitor calibration. For each yield monitor calibration bin (there are 10), the goal is to select a load where “Max Bin” matches the calibration and has the lowest Bin Sigma for all those loads. Getting a Max Bin, low Bin Sigma load for each calibration may require the combine operator to limit the grain flow range for a load by controlling either the speed of the combine or the width of the crop being cut.

In another implementation of the calibration system 10, the Bin Sigma score may be used with other calibration load profile evaluation methods to apply a weighting factor to an individual calibration load profile. The calibration process takes some number of selected calibration load profiles and performs a sequence of adjustments on the calibration numbers to minimize the total error between the estimated weight of the calibration load profiles and the actual (measured) weight of the calibration loads. The use of a weighting factor for the calibration load profile would adjust the error value during the calibration process. The result is that calibration loads with a higher weighting factor would have more of an effect on the calibration. The reason for using a weighting factor, as opposed to an acceptance threshold, is that this method allows more calibration load profiles to be used in the calibration process but reduces the influence of calibration load profiles where the evaluation methods have determined that they may have higher error.

Combine Speed Distribution and Score

Unload Automation. Most combine harvest operations unload harvested grain while the combine 12 is moving and harvesting grain. This improves the efficiency of the operation because the combine can cover more acres in a finite time period when it does not have to stop to unload. The efficiency comes at a cost though as the combine operator must manage guiding the combine through unharvested crop while also managing the deployment and activation of the unload auger. Managing the combine unload also requires the combine operator to monitor the fill of the grain cart so it is not overfilled, and grain is spilled. The components of the calibration system 10 convey the weight of the grain cart to the combine in near real time. The system 10 also has sensors 30A-G that monitor the empty status of the combine grain tank and the status of the unload auger. This information, when combined in the calibration system 10, enables automated shut off for the unload auger.

In these implementations of the system 10, when the grain cart 14 has remaining capacity to fully receive the grain stored in the combine grain tank and the combine grain tank reaches an empty condition, the unload auger can be shut off automatically. After the empty sensor in the combine grain tank indicates empty, there will be a small amount of grain in the combine grain tank left to unload along with the grain in the unload auger. If the unload auger is shut off at the point the grain tank empty sensor indicates empty, there will still be grain in the combine that can be unloaded. Monitoring the weight of the grain cart will show increasing weight if the combine is still unloading grain, even after the indication of a grain tank empty state. The system waits until the grain cart weight stops increasing for a certain amount of time after the grain tank empty indication before automatically shutting off the unload auger. The amount of time to delay unload auger shut off after grain tank weight stops increasing is dependent on the crop being unloaded, the unload system on the combine, and the grain cart weighing system. This time can be hard coded by crop type, determined by the combine model and crop type, or set by the combine operator. The time delay should be the minimum time that allows the unload auger to sufficiently empty.

Rather than using time, automatic unload auger shutoff may utilize a rotational sensor on the shaft of the unload auger or some other rotating component in the combine unloading system that allows the rotations of the unload auger to be measured. For this method, once the combine grain tank empty sensor indicates the empty state, the system would wait until the required amount of unload auger rotations has occurred before shutting off the unload auger. Like the timing of the previous method, the number of rotations needed to completely unload the combine grain tank and unload auger is dependent on the unload system of the combine. It is likely that the required rotations would be determined by the combine model and crop or set by the combine operator.

Another implementation of the system 10 utilizing automatic unload auger shutoff comprises a material-out sensor 30G at the end of the unload auger. A material out sensor would detect grain flowing out of the unload auger. When the unload auger is running and the material out sensor stops detecting the flow of grain from the unload auger (after the combine empty sensor has indicated empty), the unload auger can be shut off.

When the grain tank remaining capacity is less than the grain stored in the combine grain tank, the unload auger can be shut off automatically when the grain cart reaches full capacity as measured by its weight. Automatic shut off on grain cart full helps prevent over-filling a cart and spilling grain over the side.

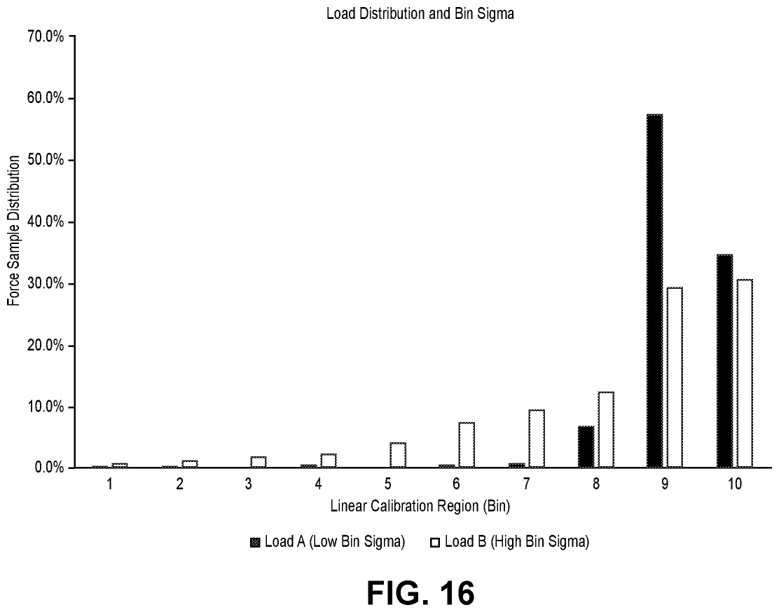

Calibration Load Profile Evaluation. Various implementations of the system validate or verify calibration load profiles through analysis of flow consistency weighting (see, e.g., box 91 in FIG. 2B). For the yield monitor system described in U.S. Pat. Nos. 5,343,761 and 5,369,603, experience in using and analyzing the system shows that calibration performance (i.e., achieving system accuracy) tends to be dependent on the calibration loads having a consistent flow of grain during data collection. Load consistency means that a large portion of the force samples collected for a load fall within one of the linear calibrated ranges within the overall force-flow range for grain harvest. A valuable set of calibration loads is a series of loads that have a large portion of force samples within one of the linear calibrated ranges where those loads occur across the force-flow range for harvesting. Refer to FIG. 16 for a graphical example of consistency in calibration loads, where the bar graph shows force distribution over the linear calibrated force ranges or bins. Notice that Load A has a high concentration of force samples in bin 9 (57.4%) while the distribution of force samples in Load B are more spread out across the bins.

It is also known that consistent flow is often dependent on consistent machine speed during harvest (calibration load data collection). A calibration load profile collection that includes a lot of stops, starts, turn-arounds, and backups produces a lot of inconsistent grain flow (i.e., force samples). Using these inconsistent loads in the calibration process tends to produce poor performing (less accurate) calibrations. A calibration system 10 that is constantly collecting calibration loads will often get calibration load profiles that include the conditions that degrade calibration performance. Calibration performance of a calibration system 10 will be better if it avoids using these calibration loads to formulate the yield monitor calibration. Accordingly, the system 10 according to certain implementations can be configured to weight calibration load profiles with consistent flow to have greater influence on the calibration of the system.

Consequently, in certain implementations, the calibration system 10 is configured to measure calibration load profile quality to improve system accuracy. The yield monitor 28 system and flow sensor 30A are already producing force data that represents grain flow during harvesting, so the calibration system 10 already has the force samples and how they fit within the calibrated ranges. At a minimum the calibration system 10 should also log the combine speed. It may also log the combine direction, threshing state, feeder height, and orientation (roll and pitch). The system 10 then includes the concept of calibration load profile evaluation where one or more parameters of the calibration load collection process are logged and analyzed for the purpose of determining if and how a recorded calibration load profile is used as part of the yield monitor calibration process.

Combine Mass Flow Sensor Force Distribution and Score. For evaluating grain flow/force consistency for a calibration load, the calibration system 10 may also apply a score (box 91 in FIG. 2B) to each recorded calibration load profile. One method used for evaluating force bin distribution is called “Bin Sigma”, which is calculated similar to a standard deviation. A lower value for Bin Sigma generally indicates a more consistent mass flow for the calibration load profile which makes it more desirable for calibration. For the yield monitor system that uses a calibration method described in U.S. Pat. No. 5,369,603, the teachings of which are incorporated by reference in its entirety, force samples and force counts are accumulated into a series of 10 “force bins” according to the force measured by the mass-flow sensor. Within each force bin, the calibration is a linear factor that translates the measured force into a mass flow. The first step in calculating Bin Sigma for a calibration load profile is to determine which force bin has the most accumulated force (called “Max Bin”). This is done by finding the maximum of the force bin average, which is calculated as the force accumulation for the bin divided by the total force accumulation. Once the Max Bin has been determined, the average force (average load force) is calculated as the force accumulation for the Max Bin divided by the force counts for the Max Bin. Now, for each of the force bins, the average force for the bin (Average Bin Force) is calculated as the force accumulation for the bin divided by the force counts for the bin. The “Bin Error” is calculated as the difference between the Average Bin Force and Average Load Force, this value squared and then multiplied by the number of force counts for the bin. The accumulated Bin Error for all force bins is divided by the total number of force counts to give Normalized Accumulated Bin Error. The Bin Sigma is the square root of the Normalized Accumulated Bin Error. Refer to Tables 1 and 2 below for examples in calculating Bin Sigma. An example is shown for a low Bin Sigma load and a high Bin Sigma load. FIG. 16 shows the load distribution for the two loads, one with a low Bin Sigma and one with a high Bin Sigma.

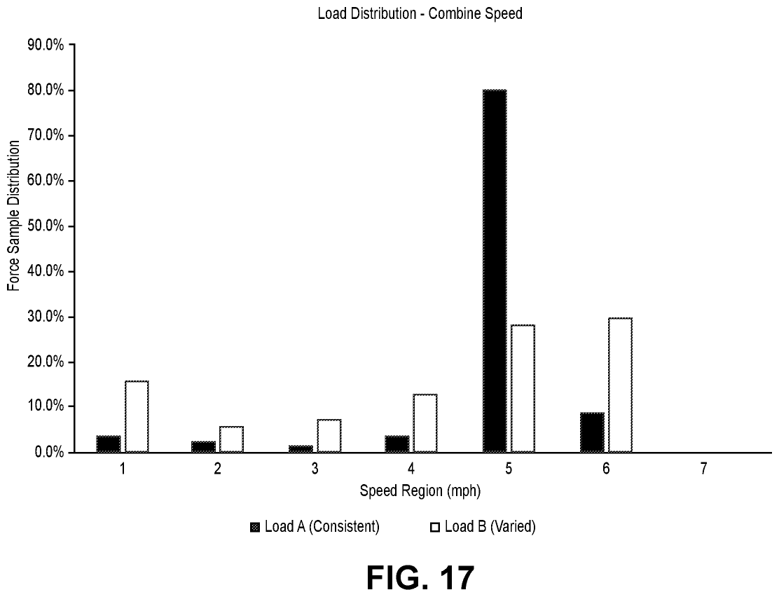

The combine speed (box 65 in FIG. 2A) may be logged and analyzed similar to the way force samples are logged and analyzed to determine load distribution and Bin Sigma. Consider the two loads shown in FIG. 17 where the combine speed has been allocated to speed ranges or bins (Bin 1=0-1 mph, Bin 2=1-2 mph, and so on . . . ). It is clear from the distribution that the speed for Load A is much more consistent than Load B.

It has been established that good yield monitor 28 calibration loads have consistent flow, consistent speed, and a minimum number of in-field stops and turn-arounds. We may evaluate the combine speed during a calibration load profile collection and assign a speed consistency score that is used in the overall evaluation of a recorded calibration load profile for acceptance and/or a weighting factor. One of the reasons for this approach is that the distribution of data can be analyzed using a much smaller amount of computer memory than having to store and recall every sample in the calibration load profile. Each speed sample increments a counter for the speed region that represents the speed sample. For example, if the combine speed sample is 4.5 mph, the counter for speed region 5 is incremented. Speed region 5 represents all speed samples greater than or equal to 4 mph and less than 5 mph. An average speed is calculated by multiplying the number of speed samples in a region by the midpoint of the speed region (e.g. region 5=4.5) with the sum from all speed regions divided by the total number of speed samples. Next, for each region, the average speed is subtracted from the midpoint and squared. This value is multiplied by the number of speed samples in the region. This represents the region error. The region errors are summed and then divided by the total number of speed samples for all regions. This represents the total error (normalized). The square root of the total error is calculated to produce the speed distribution score.

The Bin Sigma and Speed Distribution Score methods presented here are provided as examples for evaluation and scoring (box 91) methods for yield monitor calibration load profiles that may be used to influence the calibration process and when and how calibration loads are used. However, there are other methods for evaluating calibration load quality that can be used. The concept of calibration load evaluation should not be limited only to the methods presented here.

While certain implementations of the disclosed calibration system 10 use a wireless data link 16 to transfer the grain cart weight to the combine for use via software on the combine display unit 18/operations unit 32, further implementations utilize a cloud 42 computing system to implement the calibration process, as is also shown in FIG. 1A-B. In these cloud calibration system 10, the cloud computing system performs data storage and processing functions for the calibration components and vehicles 12, 14. Access to the cloud computing system occurs through a wireless internet connection (cellular modem, WiFi Hotspot) for the field computer in each vehicle (combine(s) and grain cart(s)), as would be understood and as shown at the communications 16A, 16B in FIG. 1B, which can be separate or fully integrated into the operations unit 32/display, as would be readily appreciated.

In certain cloud-based implementations of the calibration system 10, the combine 12 collects yield monitor 28 inputs as well as other optional sensor data as well as unload status data, and empty status data along with GPS time and position, for example, as has been described above, for use by the system 10 via a cloud 42 connection, as would be understood. One data collection strategy for the combine 12 is to collect all yield monitor 28 and empty and unload status information and upload it to the cloud computing system 42. Another strategy is where the combine 12 creates calibration load profiles in the method described herein using the unload auger and combine grain tank empty sensors. In these implementations, the combine 12 can also be configured to track each unload based on the unload auger sensor status. The resulting calibration load profile(s) and combine unload information is packaged and uploaded to the cloud computing system 42 for processing.

In these implementations, the grain cart side of the cloud-based calibration system 10 collects weight information for the grain cart along with GPS time and position. One data collection strategy for the grain cart is to just collect all weight information (along with GPS time and position) and upload it to the cloud computing system. Another strategy for the grain cart is to utilize an unload detection algorithm (as previously described) to determine when to collect data and upload it to the cloud computing system. Grain cart weight information, along with GPS position and time, may be collected for a period before and after an unload is detected. The unload detection algorithm may be more complex and determine the starting and stopping weights for the unload along with the GPS position and time information. This information is packaged and uploaded to the cloud computing system.

The cloud-based calibration system 10 running on the cloud computing system 42 receives the calibration information from both the combine 12 and the grain cart 14. It then uses the time and position information contained in the calibration information to synchronize the grain cart weight to the correct combine unloads, which are tied to the calibration load profiles. The Cloud Calibration system 10 then can use the calibration load profiles to determine the yield monitor calibration for the combine. As the yield monitor calibration is calculated or adjusted, the calibration is sent from the cloud-based calibration system 10 back to the combine 12. The combine field computer updates its on-board yield monitor calibration to produce more accurate results for the combine operator.

The cloud-based calibration system 10 just described may be implemented for one or more combines and one or more grain carts. When there are multiples of either combine or grain cart, the information uploaded to the cloud computing system includes a unique identifier for the machine. The cloud computing system uses the vehicle identifier to match the combine calibration load profile and unload information to the corresponding grain cart unload weight information. The cloud-based calibration system 10 is then able to determine a unique calibration for each combine. It is also able to individually process the grain cart information and can apply the calibration and weight adjustment strategies that have been described for the grain cart weighing system.

The grain trucks hauling the harvested grain to the terminal scale may also participate in the cloud calibration system 10. Truck location (box 70 in FIG. 2A) and time information is uploaded to the cloud 42 computing system. The cloud calibration system 10 uses the grain truck time and location to synchronize the grain cart load transfers to the terminal scale weights. Terminal scale weights can be added to the cloud computing system by the truck operator utilizing a smart phone application. It is also conceived that the terminal scale may be able to automatically communicate the scale weights to the cloud computing system.

The cloud calibration system 10 described above uses internet connectivity and cloud computing to receive data and update the calibration. this live connection is not absolutely required for an implementation of a remote calibration system 10. Another implementation would collect the combine yield monitor and grain cart data as described, but the data would be transferred to removable (transportable) media, which would then be used to transfer the information to a remote computer. The remote computer would process the data to determine the necessary calibrations for each combine. The remote computer would use the calibrations in processing all the yield monitor data. The updated calibrations may be transferred to a removable media and taken back to the combine field computer for updating the calibration. The only real difference then from the system described above is that the transfer of the information requires removable media and not and internet connection.

Although the disclosure has been described with reference to preferred implementations, persons skilled in the art will recognize that changes may be made in form and detail without departing from the spirit and scope of the disclosed apparatus, systems and methods.

1. An automatic calibration system comprising:
a) a combine vehicle system, comprising:
i) a first operations unit;
ii) at least one combine sensor; and
iii) a yield monitor configured to collect yield monitor data from the at least one combine sensor;
b) a grain cart vehicle system, comprising a second operations unit configured to collect grain cart system data; and
c) a data link between the combine vehicle system and grain cart vehicle system,
wherein the calibration system is configured to:
record a calibration load profile from the collected yield monitor data;
verify the recorded calibration load profile with grain cart system data;
update the calibration load profile; and
calibrate the yield monitor with the updated calibration load profile.

2. The automatic calibration system of claim 1, wherein the at least one combine sensor comprises a mass flow sensor and the calibration system is configured to calibrate the mass flow sensor.

3. The automatic calibration system of claim 1, wherein the calibration system is configured to determine that the combine grain tank is empty via unload timing, via unload rotations, via material out sensor or via grain cart weight system.

4. The automatic calibration system of claim 1, further comprising at least one GNSS system.

5. The automatic calibration system of claim 1, wherein the first operations unit is housed in a display.

6. The automatic calibration system of claim 1, further comprising a cloud system.

7. The automatic calibration system of claim 1, wherein the yield monitor data comprises at least one of raw mass sensor force data or flow data, crop type data, calibration load time and date, calibration load duration, moisture data, number of unloads and crop variety data.

8. An automatic calibration system comprising:
a) a combine vehicle system, comprising a yield monitor configured to collect yield monitor data from at least one combine sensor;
b) a grain cart vehicle system configured to collect grain cart system data; and
c) a data link between the combine vehicle system and grain cart vehicle system,
wherein the calibration system is configured to:
record a calibration load profile from the collected yield monitor data;
update the calibration load profile; and
calibrate the yield monitor with the updated calibration load profile.

9. The automatic calibration system of claim 8, wherein the yield monitor data comprises at least one of raw mass sensor force data or flow data, crop type data, calibration load time and date, calibration load duration, moisture data, number of unloads and crop variety data.

10. The automatic calibration system of claim 9, wherein the grain cart system data comprises at least one of grain cart weighing system data, grain cart ID data, grain cart start weight data, grain cart location data, grain cart loading or unloading date and time, grain cart tilt, roll and pitch, grain cart speed data during loading or unloading, grain cart stop weight data, and grain cart load duration data.

11. The automatic calibration system of claim 9, configured to process and verify calibration load profiles and apply corrections.

12. An automatic calibration system comprising:
a) a combine vehicle system, comprising a yield monitor configured to collect yield monitor data and record a calibration load profile from the collected yield monitor data; and
b) a grain cart vehicle system comprising a grain cart weighing system configured to compile grain cart weight data,
wherein the combine vehicle system and grain cart vehicle system are in operational communication and are configured to automatically calibrate at least one of the yield monitor and/or grain cart weighing system.

13. The automatic calibration system of claim 12, further comprising a data link between the combine vehicle system and grain cart vehicle system.

14. The automatic calibration system of claim 12, wherein the grain cart weighing system is configured to be calibrated via linear correction.

15. The automatic calibration system of claim 12, wherein the grain cart weighing system is configured to be calibrated via non-linear correction.

16. The automatic calibration system of claim 12, wherein the yield monitor and weighing systems are configured to be initially calibrated by comparing start and stop weights with ground truth weights.

17. The automatic calibration system of claim 12, wherein yield monitor and grain cart weighing system are configured to be automatically calibrated for crop conditions.

18. The automatic calibration system of claim 12, wherein configured to score calibration load profiles via bin sigma and/or speed distribution score.

19. The automatic calibration system of claim 12, configured to execute a linear increasing correlator to establish at least one of unload start time and/or unload stop time.

20. The automatic calibration system of claim 12, configured to process grain cart load profiles and/or grain cart weight system weight by applying at least one correction selected from the group consisting of:
an upper and lower range calibration;
a linear calibration correction;
a bi-linear calibration correction;
a multi-point calibration correction;
a motion correction;
a crop type corrections;
a combine speed correction; and
a grain cart speed correction.

20. (canceled)
